(19) United States
(12) Patent Application Publication
(10) Pub. No.: US 2025/0303759 A1
(43) Pub. Date: Oct. 2, 2025

(54) PAPER FEEDING UNIT AND PRINTING APPARATUS

(71) Applicant: SEIKO EPSON CORPORATION, Tokyo (JP)

(72) Inventors: Satoshi NAKATA, MATSUMOTO-SHI (JP); Katsumi YAMADA, MATSUMOTO-SHI (JP)

(21) Appl. No.: 19/092,138

(22) Filed: Mar. 27, 2025

(30) Foreign Application Priority Data
Mar. 29, 2024 (JP) 2024-055493
Mar. 29, 2024 (JP) 2024-055576

(51) Int. Cl. B41J 15/04; B41J 11/70; B41J 13/10; B65H 1/04; B65H 16/02

(52) U.S. Cl. CPC B41J 15/04; B41J 11/70; B41J 13/103; B65H 1/04; B65H 16/028

(57) ABSTRACT

A paper feeding unit includes a paper feeding tray that is supported, between a predetermined attachment position and a predetermined drawing-out position, by a housing to be capable of sliding in parallel to a predetermined drawing-out direction and is capable of storing a winding body for roll paper and a rotating section configured to rotate the winding body according to drawing-out operation of moving the paper feeding tray from the attachment position to the drawing-out position. The attachment position is a position where the roll paper is let out from the paper feeding tray among positions to which the paper feeding tray is capable of sliding in the housing, the drawing-out position is a position a predetermined distance separated from the attachment position in the drawing-out direction among the positions to which the paper feeding tray is capable of sliding in the housing, and the rotating section causes, by rotating the winding body in a reverse rotating direction, the winding body to wind a part of the roll paper let out from the winding body.

The present application is based on, and claims priority from JP Application Serial Number 2024-055493, filed Mar. 29, 2024 and JP Application Serial Number 2024-055576, filed Mar. 29, 2024, the disclosures of which are hereby incorporated by reference herein in their entirety.

### BACKGROUND

### 1. Technical Field

The present disclosure relates to a paper feeding unit and a printing apparatus.

### 2. Related Art

Researches and developments for a printing apparatus that prints an image on a print medium have been performed.

Concerning the researches and developments, there is known a paper feeding unit including a paper feeding tray capable of storing a winding body for roll paper and a housing that detachably supports the paper feeding tray, the paper feeding unit including a return feeding mechanism that feeds the roll paper, which is let out from the winding body, toward the winding body in association with an operation of moving the paper feeding tray in a direction orthogonal to a rotation axis of the winding body and detaching the paper feeding tray from the housing (see JP-A-2021-054602).

JP-A-2021-054602 is an example of the related art.

Here, in the paper feeding unit described in JP-A-2021-054602, the return feeding mechanism is a roller that nips the let-out roll paper. For this reason, in the paper feeding unit, the let-out roll paper can be returned. On the other hand, in some cases, the winding body cannot be rotated and the roll paper equivalent to a returned amount is not wound by the winding body and is bent.

### SUMMARY

According to an aspect of the present disclosure, there is provided a paper feeding unit including: a paper feeding tray that is supported, between a predetermined attachment position and a predetermined drawing-out position, by a housing to be capable of sliding in parallel to a predetermined drawing-out direction and is capable of storing a winding body for roll paper; and a rotating section configured to rotate the winding body according to drawing-out operation of moving the paper feeding tray from the attachment position to the drawing-out position, wherein the attachment position is a position where the roll paper is let out from the paper feeding tray by a printing apparatus among positions to which the paper feeding tray is capable of sliding in the housing, the drawing-out position is a position a predetermined distance separated from the attachment position in the drawing-out direction among the positions to which the paper feeding tray is capable of sliding in the housing, and the rotating section causes, by rotating the winding body in a reverse rotating direction opposite to a forward rotating direction that is a rotating direction of the winding body in a case in which the roll paper is let out from the winding body, the winding body to wind a part of the roll paper let out from the winding body.

According to another aspect of the present disclosure, there is provided a printing apparatus including: the paper feeding unit explained above; and a printing section, wherein the paper feeding tray is capable of storing one or more pieces of cut paper instead of the winding body, and the printing section prints an image on the roll paper let out from the winding body stored in the paper feeding tray or on the cut paper.

### BRIEF DESCRIPTION OF THE DRAWINGS

FIG. 1 is a perspective view illustrating an example of an exterior of a printing apparatus according to a first embodiment.

FIG. 2 is a perspective view illustrating an example of a configuration of a paper feeding unit.

FIG. 3 is a side view of the paper feeding unit illustrated in FIG. 2.

FIG. 4 is a diagram illustrating an example of a state in which a paper feeding tray is locked to a housing by a lock section.

FIG. 5 is a diagram illustrating an example of a state in which the lock of the paper feeding tray to the housing by the lock section illustrated in FIG. 4 is released.

FIG. 6 is a perspective view illustrating an example of a configuration of a rotating section.

FIG. 7 is a top view of the rotating section illustrated in FIG. 6.

FIG. 8 is a perspective view illustrating an example of a configuration of a rotating section according to a modification 1 of the first embodiment.

FIG. 9 is a perspective view in which the rotating section illustrated in FIG. 8 is viewed from another direction.

FIG. 10 is a side cross-sectional view illustrating an example of a configuration of each of a reverse conveyance section and a rotating section according to a modification 2 in the first embodiment.

FIG. 11 is a perspective view illustrating an example of each of an operation section and a rotating section provided in the paper feeding unit.

FIG. 12 is a top view of the operation section and the rotating section illustrated in FIG. 11.

FIG. 13 is a diagram illustrating an example of a state in which an operation section, which is a lever, is provided in the paper feeding tray.

FIG. 14 is a perspective view illustrating an example of the rotating section in a state in which the operation section, which is the lever, is located at the uppermost position in the paper feeding tray.

FIG. 15 is a perspective view illustrating an example of a rotating section in a state in which the operation section, which is the lever, is located at the lowermost position in the paper feeding tray.

FIG. 16 is a perspective view illustrating an example of an exterior of a paper feeding unit including an operation section.

FIG. 17 is a perspective view illustrating an example of a configuration of a rotating section.

FIG. 18 is a front cross-sectional view of the rotating section illustrated in FIG. 17.

FIG. 19 is a diagram illustrating an example of a configuration of each of an operation section and a rotating section provided in the paper feeding unit.

FIG. 20 is a diagram illustrating an example of a configuration of each of the operation section and a rotating section provided in the paper feeding unit.

FIG. 21 is a perspective view in which each of the operation section and the rotating section illustrated in FIG. 20 is viewed from another direction.

### DESCRIPTION OF EMBODIMENTS

### First Embodiment

A first embodiment of the present disclosure is explained below with reference to the drawings.

### Overview of a Printing Apparatus According To The First Embodiment

First, an overview of a printing apparatus according to the first embodiment is explained.

The printing apparatus according to the first embodiment includes a paper feeding unit and a printing section. The paper feeding unit includes a paper feeding tray and a rotating section. The paper feeding tray is a tray that is supported by, between a predetermined attachment position and a predetermined drawing-out position, a housing to be capable of sliding in parallel to a predetermined drawing-out direction and that can store a winding body for roll paper. The rotating section rotates the winding body according to drawing-out operation of moving the paper feeding tray from the attachment position to the drawing-out position. Here, the attachment position is a position where the roll paper is let out from the paper feeding tray by the printing apparatus among positions to which the paper feeding tray is capable of sliding in the housing. The drawing-out position is a position a predetermined distance separated from the attachment position in the drawing-out direction among the positions to which the paper feeding tray is capable of sliding in the housing. The rotating section causes, by rotating the winding body in a reverse rotating direction opposite to a forward rotating direction, which is a rotating direction of the winding body in the case in which the roll paper is let out from the winding body, the winding body to wind a part of the roll paper let out from the winding body. In addition, the printing section prints an image on the roll paper let out from the winding body stored in the paper feeding tray or on cut paper. Accordingly, the printing apparatus can prevent the roll paper from bending when causing the winding body to wind the roll paper according to the drawing-out operation.

In the following explanation, a configuration of the printing apparatus according to the first embodiment is explained in detail.

### Configuration of the Printing Apparatus According to the First Embodiment

The configuration of the printing apparatus according to the first embodiment is explained below taking a printing apparatus 1 as an example. In the first embodiment, for convenience of explanation, a user of the printing apparatus 1 is simply referred to as user.

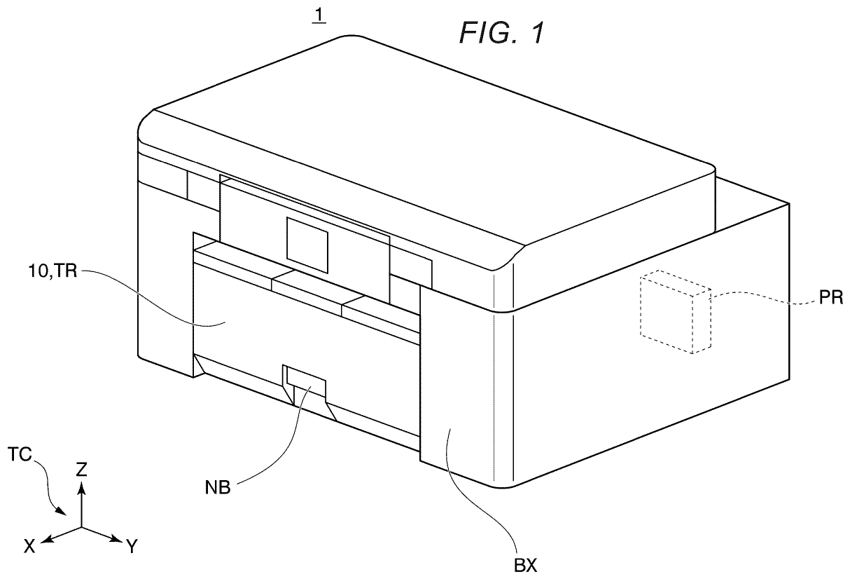

FIG. 1 is a perspective view illustrating an example of an exterior of the printing apparatus 1 according to the first embodiment.

Here, in the present specification, a three-dimensional coordinate system TC is a three-dimensional orthogonal coordinate system indicating a direction in a figure in which the three-dimensional coordinate system TC is drawn. In the following explanation, for convenience of explanation, an X axis in the three-dimensional coordinate system TC is simply referred to as X axis. In the following explanation, for convenience of explanation, a Y axis in the three-dimensional coordinate system TC is simply referred to as Y axis. In the following explanation, for convenience of explanation, a Z axis in the three-dimensional coordinate system TC is simply referred to as Z axis. In the following explanation, as example, a case in which a negative direction of the Z axis coincides with the direction of gravity is explained. Accordingly, in the following explanation, for convenience of explanation, a positive direction of the Z axis is referred to as upward direction or simply as upward and a negative direction of the Z axis is referred to as downward direction or simply as downward.

In the following explanation, for convenience of explanation, a surface on the positive direction side of the X axis among surfaces of the printing apparatus 1 is referred to as front surface of the printing apparatus 1 and a surface on the negative direction side of the X axis among the surfaces of the printing apparatus 1 is referred to as rear surface of the printing apparatus 1. In the following explanation, viewing an object while facing a certain direction is referred to as viewing the object in the certain direction.

The printing apparatus 1 prints an image on roll paper RP let out from a winding body RB around which the roll paper RP is wound or on a cut print medium. The print medium may be any medium if the print medium is a cut sheet-shaped medium such as cut print paper or a sticker mount. In the following explanation, for convenience of explanation, the cut print medium is simply referred to as cut paper CP.

The printing apparatus 1 includes a paper feeding unit 10 and a printing section PR. The printing apparatus 1 may include other members, other devices, and the like in addition to the paper feeding unit 10 and the printing section PR. In FIG. 1, in order to simplify the figure, the printing section PR is drawn as a rectangular parallelepiped object.

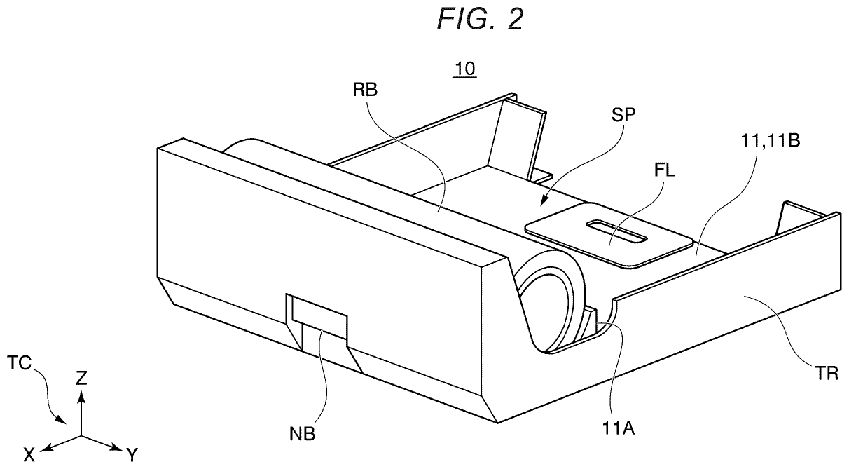

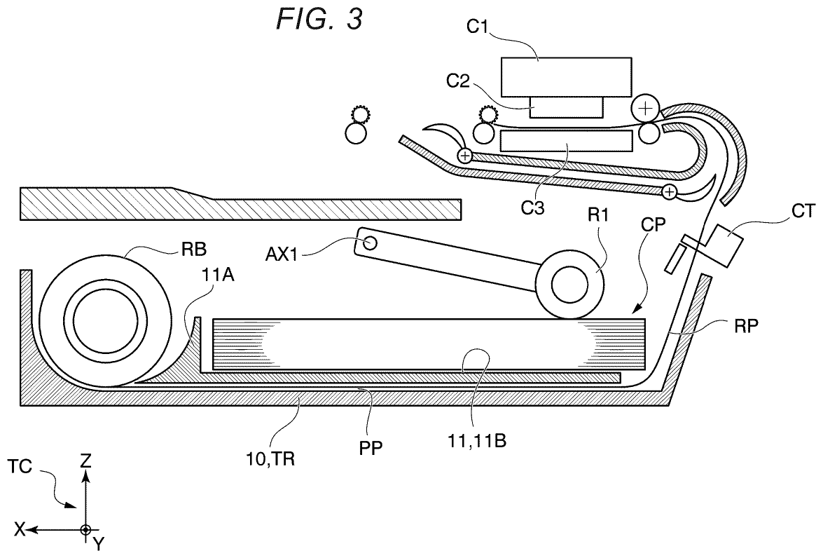

FIG. 2 is a perspective view illustrating an example of a configuration of the paper feeding unit 10. FIG. 3 is a side view of the paper feeding unit 10 illustrated in FIG. 2. However, in FIG. 3, unlike FIG. 2, a plurality pieces of cut paper CP are stored in the paper feeding unit 10 together with the winding body RB.

The paper feeding unit 10 includes a paper feeding tray TR and a lock section LK.

In the example illustrated in FIGS. 2 and 3, the paper feeding tray TR is a box-shaped tray in which a recess opened upward is formed. The shape of the paper feeding tray TR may be another shape instead of the shape illustrated in FIG. 2. A space SP in the recess of the paper feeding tray TR is a space capable of storing the winding body RB. That is, the paper feeding tray TR is a tray capable of storing the winding body RB. The space SP may be a space capable of storing one or more pieces of cut paper CP together with the winding body RB or may be a space capable of storing the winding body RB and incapable of storing the one or more pieces of cut paper CP. The space SP may be capable of storing the winding body RB when the one or more pieces of cut paper CP are not stored and may be capable of storing the one or more pieces of cut paper CP when the winding body RB is not stored. That is, a region where the winding body RB is disposed in the space SP may overlap at least a part of the region where the one or more pieces of cut paper CP are disposed in the space SP or may not overlap the region where the one or more pieces of cut paper CP are disposed in the space SP. In the following explanation, as an example, a case in which the space SP is the space capable of storing the one or more pieces of cut paper CP together with the winding body RB is explained. That is, in this example, the paper feeding tray TR is capable of storing the one or more pieces of cut paper CP together with the winding body RB. Accordingly, the printing apparatus 1 can improve usability because the printing apparatus 1 can select one of the roll paper RP and the cut paper CP stored in the paper feeding tray TR and perform printing.

The paper feeding tray TR is supported by a housing BX to be capable of sliding in parallel to a predetermined drawing-out direction between a predetermined attachment position and a predetermined drawing-out position. In the following explanation, as an example, a case in which the drawing-out direction coincides with the positive direction of the X axis is explained. The housing BX may be configured separately from the printing apparatus 1 or may be configured integrally with the printing apparatus 1. In the following explanation, as an example, as illustrated in FIG. 1, a case in which the housing BX is configured integrally with the printing apparatus 1 is explained. Here, the attachment position is a position where the roll paper RP is let out from the paper feeding tray TR by the printing apparatus 1 among positions to which the paper feeding tray TR is capable of sliding in the housing BX. The drawing-out position is a position a predetermined distance separated from the attachment position in the drawing-out direction among the positions to which the paper feeding tray TR is capable of sliding in the housing BX. The predetermined distance may be any distance. For example, the drawing-out position is a position closest to the drawing-out direction side among the positions to which the paper feeding tray TR is capable of sliding in the housing BX. The paper feeding tray TR may be detachable from the housing BX or may be undetachable from the housing BX. When the housing BX is configured separately from the printing apparatus 1, the housing BX may be provided in the paper feeding unit 10.

When the paper feeding tray TR is attached to the printing apparatus 1, the surface on the positive direction side of the X axis among the surfaces of the paper feeding tray TR configures a part of the front surface of the printing apparatus 1. Thus, in the following explanation, for convenience of explanation, the surface on the positive direction side of the X axis among the surfaces of the paper feeding tray TR is referred to as front surface of the paper feeding tray TR.

Here, the winding body RB is stored in the paper feeding tray TR to be located on further on the front surface side of the paper feeding tray TR than the one or more pieces of cut paper CP. The winding body RB is stored in the paper feeding tray TR such that a rotation axis of the winding body RB is parallel to the front surface of the paper feeding tray TR. In the example illustrated in FIG. 3, in the space SP, the winding body RB is supported by each of a part of the bottom surface of the paper feeding tray TR and a member 11 provided above the bottom surface of the paper feeding tray TR. Therefore, as illustrated in FIG. 3, a connecting portion of a surface located at the bottom among surfaces forming the space SP and a surface located closest to the front surface side of the paper feeding tray TR among the surfaces forming the space SP is curved along the outer circumferential surface of the winding body RB in a direction orthogonal to the rotation axis of the winding body RB. In the following explanation, for convenience of explanation, the connecting portion is referred to as a target connecting portion.

The member 11 includes a winding body support part 11A and a cut paper support part 11B. The winding body support part 11A is a part having a curved surface curved along the outer circumferential surface of the winding body RB in a direction orthogonal to the rotation axis of the winding body RB among parts of the member 11. For this reason, the winding body RB is rotatably supported by the target connecting portion and the curved surface in the space SP. The cut paper support part 11B is a plate-shaped portion among the parts of the member 11 and is a portion having a placement surface on which the one or more pieces of cut paper CP are placed. The lower surface of the winding body support part 11A and the lower surface of the cut paper support part 11B are coupled to each other without a step.

The member 11 is separated upward from the surface located at the bottom among the surfaces forming the space SP. That is, in the paper feeding tray TR, there is a gap between the surface and the member 11. This gap functions as a roll paper passage path PP through which the roll paper RP let out from the winding body RB to the inside of the printing apparatus 1 passes. In FIG. 3, a state in which the roll paper RP is let out to the inside of the printing apparatus 1 through the roll paper passage path PP is drawn.

Here, the one or more pieces of cut paper CP stored in the paper feeding tray TR attached to the printing apparatus 1 are conveyed to the inside of the printing apparatus 1 one by one by a paper feeding roller R1 provided in the printing apparatus 1. A rotation axis of the paper feeding roller R1 is parallel to the rotation axis of the winding body RB. The paper feeding roller R1 is located above further on the front surface side than the paper feeding roller R1 and is provided in the printing apparatus 1 to be capable of swinging around a rotation axis AX1 parallel to the rotation axis of the winding body RB.

The roll paper RP let out from the winding body RB stored in the paper feeding tray TR attached to the printing apparatus 1 is also conveyed to the inside of the printing apparatus 1 by the paper feeding roller R1. For this reason, as illustrated in FIG. 2, a flap FL is provided in the cut paper support part 11B. The flap FL is a member that opens and closes an opening penetrating the cut paper support part 11B up to down. In the example illustrated in FIG. 2, the opening is closed by a flap FL. When the opening is opened by the flap FL and the cut paper CP is not stored in the paper feeding tray TR, the paper feeding roller RI comes into contact with, via the opening, the roll paper RP let out from the winding body RB by a hand of the user to the roll paper passage path PP. As a result, the paper feeding roller RI can convey the roll paper RP to the inside of the printing apparatus 1.

The roll paper RP conveyed by the paper feeding roller R1 is conveyed to the inside of the printing apparatus 1 along a dotted line arrow illustrated in FIG. 3. As illustrated in FIG. 3, the roll paper RP conveyed as explained above passes between a print head C2 supported by a carriage C1 of the printing apparatus 1 and a platen C3 of the printing apparatus 1, whereby an image is printed on the roll paper RP. The carriage C1, the print head C2, and the platen C3 configure a printing section PR in the printing apparatus 1. The roll paper RP after the image has been printed thereon by the printing section PR in the roll paper RP let out from the winding body RB is separated from, by a cutting section CT that cuts the roll paper RP, the roll paper RP before the image is printed thereon by the printing section PR in the roll paper RP let out from the winding body RB. For this reason, in the printing apparatus 1, the cutting section CT is located further on the upstream side of a conveyance path of the roll paper RP than the printing section PR. That is, the printing apparatus 1 includes the cutting section CT.

A knob NB is provided on the front surface of the paper feeding tray TR. The knob NB is a member for the user to operate the lock section LK and is a member that the user grips by a hand when drawing out the paper feeding tray TR from the housing BX. The knob NB is provided on the front surface to be capable of turning around a rotation axis parallel to the front surface. The user can operate the lock section LK by turning the knob NB.

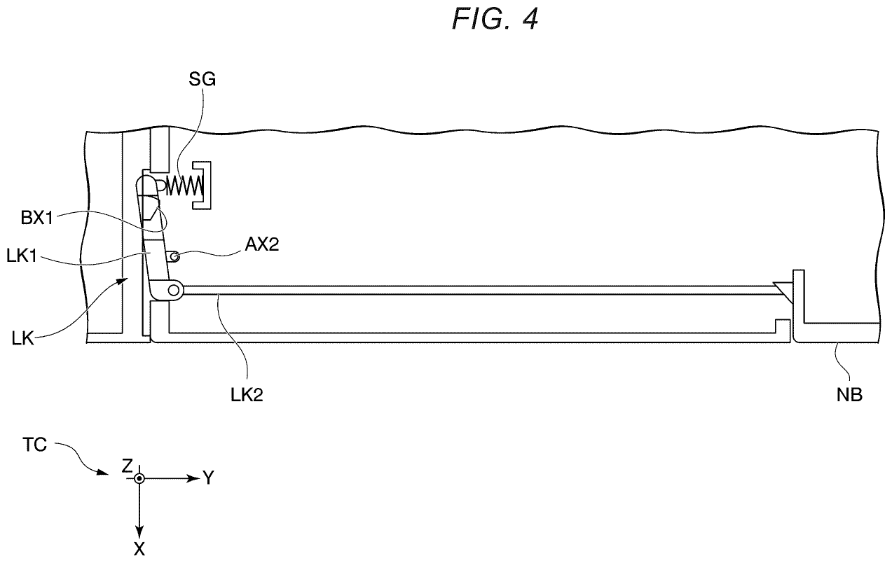

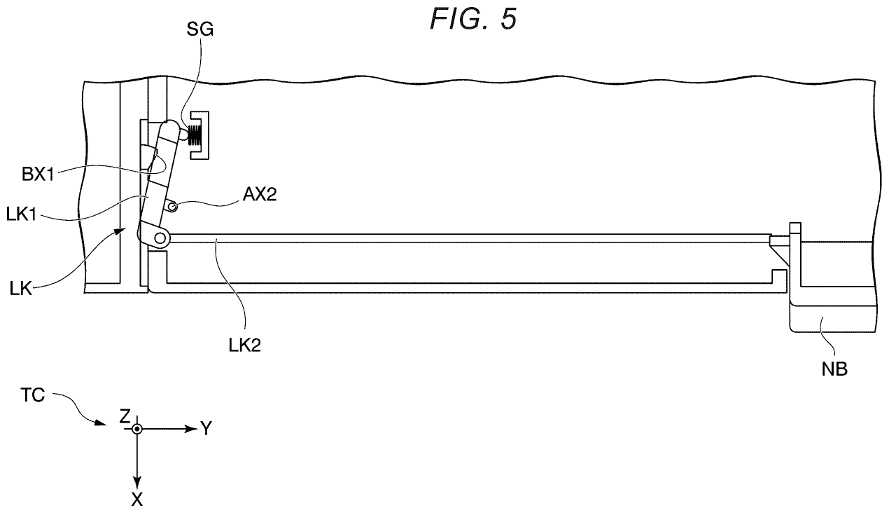

When the paper feeding tray TR is located at the attachment position, the lock section LK locks the paper feeding tray TR at the attachment position not to move with respect to the housing BX. Here, FIG. 4 is a diagram illustrating an example of a state in which the paper feeding tray TR is locked to the housing BX by the lock section LK. FIG. 5 is a diagram illustrating an example of a state in which the lock of the paper feeding tray TR to the housing BX by the lock section LK illustrated in FIG. 4 is released. The lock section LK is coupled to, via an engaging member LK1 that engages with a protrusion BX1 provided in the housing BX and a link LK2 that is a bar-shaped member, the knob NB provided in the paper feeding tray TR. That is, the lock section LK includes the engaging member LK1 and the link LK2. The engaging member LK1 is capable of turning around a predetermined rotation axis AX2 according to movement of the link LK2. According to the turning, the engaging member LK1 can switch a state between a state of being engaged with the protrusion BX1 and a state of not being engaged with the protrusion BX1. The user can turn the engaging member LK1 by turning the knob NB. When the knob NB is turned by the user drawing the knob NB to the drawing-out direction side, the engagement of the engaging member LK1 and the protrusion BX1 is released and the lock of the paper feeding tray TR to the housing BX by the lock section LK is released. On the other hand, when the knob NB is turned by the user pressing the knob NB to an attaching direction side, the engaging member LK1 is engaged with the protrusion BX1 and the lock section LK locks the paper feeding tray TR to the housing BX. Here, the attaching direction is a direction opposite to the drawing-out direction. In the examples illustrated in FIGS. 4 and 5, the lock section LK includes an biasing section SG that urges the engaging member LK1 in a direction in which the engaging member LK1 engages with the protrusion BX1. Accordingly, the lock section LK can lock the paper feeding tray TR to the housing BX when the user releases the hand from the knob NB. The biasing section SG is, for example, a coil spring but is not limited to the coil spring. The lock section LK may not include the biasing section SG.

The printing section PR prints an image on the roll paper RP let out from the winding body RB stored in the paper feeding tray TR or on the cut paper CP. As explained above, the printing section PR includes the carriage C1, the printing head C2, and the platen C3 illustrated in FIG. 3. The printing section PR may be configured to print an image on the roll paper RP let out from the winding body RB stored in the paper feeding tray TR and not to print an image on the cut paper CP. In this case, the winding body RB is stored in the paper feeding tray TR and the one or more pieces of cut paper CP are not stored therein.

In the printing apparatus 1 configured as explained above, the leading end of the roll paper RP before the image is printed thereon in the roll paper RP after being cut by the cutting section CT is located between an exit of the roll paper passage path PP and the cutting section CT. In such a case, when the user moves the paper feeding tray TR from the attachment position to the drawing-out position, the roll paper RP let out from the winding body RB is sometimes deformed by contact with surrounding members and the like provided in the housing BX. This leads to deterioration of print quality and is not desirable.

As a mechanism for solving such a problem, there is known a return feeding mechanism that feeds the roll paper RP, which is let out from the winding body RB, toward the winding body RB in association with an operation of moving the paper feeding tray TR from the attachment position to the drawing-out position. However, the return feeding mechanism is a roller that nips the roll paper RP let out from the winding body RB. For this reason, the return feeding mechanism can return the let-out roll paper RP and, on the other hand, in some case, cannot rotate the winding body RB and the roll paper RP equivalent to a returned amount is not wound by the winding body RB and is bent.

Thus, the paper feeding unit 10 further includes the rotating section RT that rotates the winding body RB according to drawing-out operation performed on the paper feeding tray TR by the user in order to move the paper feeding tray TR from the attachment position to the drawing-out position. Accordingly, the paper feeding unit 10 causes the winding body RB to wind a part of the roll paper RP let out from the winding body RB. As a result, the paper feeding unit 10 can prevent the roll paper from being bent when causing the winding body to wind the roll paper according to the drawing-out operation.

### Configuration of the Rotating Section

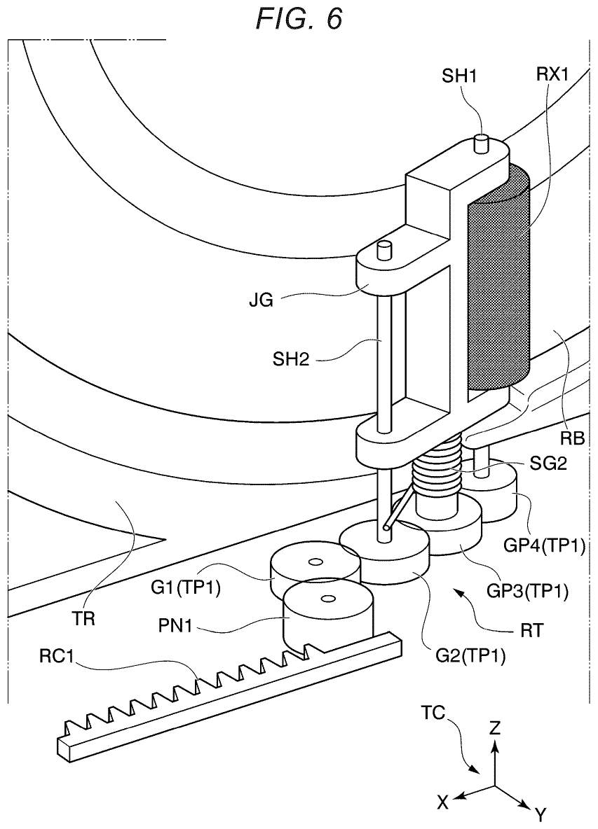

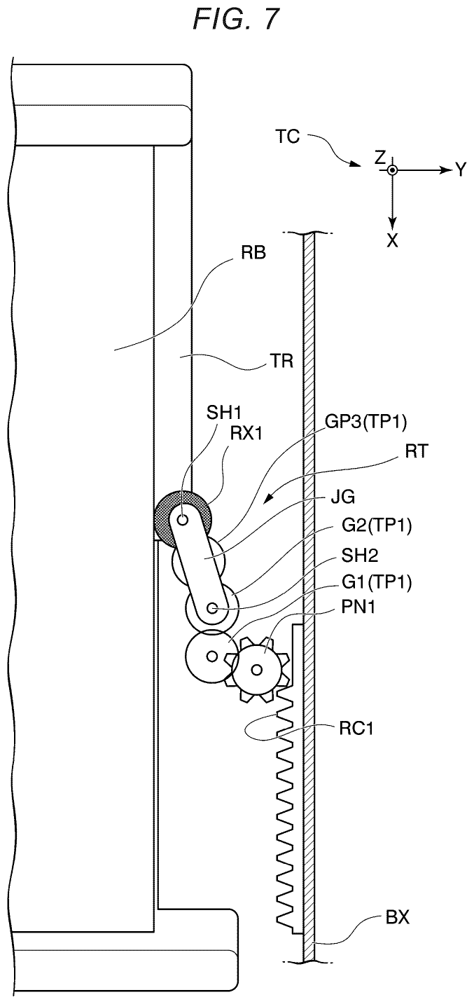

A configuration of the rotating section RT is explained below. FIG. 6 is a perspective view illustrating an example of the configuration of the rotating section RT. FIG. 7 is a top view of the rotating section RT illustrated in FIG. 6.

The rotating section RT includes a rotating body RX1, a jig JG, a rack RC1, a meshing gear PN1, a transmission section TP1, and an biasing section SG2.

The rotating body RX1 is a columnar object that rotates the winding body RB in the reverse rotating direction by rotating in a state of being in contact with one of both ends of the winding body RB in a direction parallel to the rotation axis of the winding body RB, and is, for example, a roller. The rotating body RX1 is supported by a shaft SH1, which is supported by the jig JG, to be capable of rotating around the shaft SH1. In the following explanation, for convenience of explanation, one of both ends of the winding body RB in the direction parallel to the rotation axis of the winding body RB is referred to as first end portion of the winding body RB. In the following explanation, for convenience of explanation, the other of both the ends is referred to as second end portion of the winding body RB. In the example illustrated in FIG. 6, the rotating body RX1 is capable of coming into contact with a surface located below the rotation axis of the winding body among surfaces of the first end portion. In the following explanation, for convenience of explanation, the surface is referred to as first contact surface. Since the rotating body RX1 is in contact with the first contact surface as explained above, it is possible to rotate the winding body RB without causing the roll paper RP located on the surface of the winding body RB to slide with respect to the winding body RB. That is, since the rotating body RX1 is in contact with the first contact surface, the paper feeding unit 10 can prevent failure in the rotation of the winding body RB.

The rotating body RX1 is formed of a material having a high coefficient of friction such as rubber or elastomer. Accordingly, the paper feeding unit 10 can prevent failure in the rotation of the winding body RB by the rotating body RX1. The rotating body RX1 may have a configuration in which at least a part of the outer circumferential surface of the rotating body RX1 in the direction orthogonal to the rotation axis of the rotating body RX1 is formed of the material having a high coefficient of friction. The rotating body RX1 according to the first embodiment is an example of a first rotating body.

The jig JG supports the shaft SH1. That is, the jig JG supports, via the shaft SH1, the rotating body RX1 to be capable of rotating around the shaft SH1. The jig JG is supported to be capable of turning around a shaft SH2 by the shaft SH2 supported by the transmission section TP1 explained below. The jig JG can bring the rotating body RX1 supported by the jig JG into contact with the first contact surface according to the turning around the shaft SH2. The jig JG can also separate the rotating body RX1 supported by the jig JG from the first contact surface according to the turning around the shaft SH2. For this reason, the shaft SH2 is parallel to the shaft SH1 and is separated from the shaft SH1.

The rack RC1 is a rack provided in one of the paper feeding tray TR and the housing BX. In the following explanation, as an example, a case in which the rack RC1 is provided in the housing BX is explained. In this case, the rack RC1 meshes with the meshing gear PN1 and rotates the meshing gear PN1 in a process in which the user moves the paper feeding tray TR from the attachment position to the drawing-out position. The rotation of the meshing gear PN1 is transmitted to the rotating body RX1 by the transmission section TP1. Therefore, the rack RC1 can rotate the rotating body RX1 via the transmission section TP1 by rotating the meshing gear PN1. As a result, the rack RC1 can rotate the winding body RB in the reverse rotating direction. Therefore, the rack RC1 is provided at a position where the rack RC1 is capable of meshing with the meshing gear PN1 in the process. The rack RC1 is provided not to mesh with the meshing gear PN1 when the paper feeding tray TR is located at the attachment position. This is because, if the rack RC1 meshes with the meshing gear PN1 in this case, the rotating body RX1 hinders the roll paper RP from being drawn out from the winding body RB. That is, accordingly, in this case, the rack RC1 can prevent the rotating body RX1 from hindering the roll paper RP from being let out from the winding body RB. This leads to suppression of a load on the winding body RB and, as a result, leads to suppression of deterioration in paper feeding accuracy and is useful.

The meshing gear PN1 is a pinion capable of meshing with the rack RC1. The meshing gear PN1 is provided in the other of the paper feeding tray TR and the housing BX. For this reason, in this example, the meshing gear PN1 is provided in the paper feeding tray TR.

The transmission section TP1 transmits the rotation of the meshing gear PN1 to the rotating body RX1 to rotate the rotating body RX1. The transmission section TP1 includes, for example, a plurality of gears and transmits the rotation of the meshing gear PN1 to the rotating body RX1 with the plurality of gears. The transmission section TP1 may be configured to transmit the rotation of the meshing gear PN1 to the rotating body RX1 with another member, another device, another mechanism, or the like, instead of the plurality of gears. A part or the entire transmission section TP1 may be provided in the housing BX. Here, when the rotating body RX1 of the transmission section TP1 is provided in the housing BX, the user can rotate the winding body RB with a frictional force generated between the rotating body RX1 and the winding body RB when the paper feeding tray TR is moved in the drawing-out direction. However, it can also be considered that, when the rotating body RX1 of the transmission section TP1 is provided in the paper feeding tray TR, it is possible to prevent unnecessary friction from occurring between the rotating body RX1 and the winding body RB.

In the example illustrated in FIGS. 6 and 7, the transmission section TP1 includes four gears of gears G1 to G4. In FIG. 7, the gear G4 is hidden behind the rotating body RX1 and is not seen. The gear G1 meshes with each of the meshing gear PN1 and the gear G2 and transmits rotation of the meshing gear PN1 to the gear G2. The gear G2 meshes with each of the gear G1 and the gear G3 and transmits rotation of the gear G1 to the gear G3. The gear G3 meshes with each of the gear G2 and the gear G4 and transmits rotation of the gear G2 to the gear G4. The gear G4 is coupled to, by the shaft SH1, the rotating body RX1 to rotate in association with the rotating body RX1. More specifically, the shaft SHI couples each of the gear G4 and the rotating body RX1 to overlap each of a rotation axis of the gear G4 and the rotation axis of the rotating body RX1. For this reason, the rotating body RX1 rotates in association with the rotation of the gear G4. As explained above, the transmission section TP1 transmits the rotation of the meshing gear PN1 to the rotating body RX1 with the four gears to rotate the rotating body RX1. The first transmission section TP1 is an example of a first transmission section.

In the example illustrated in FIGS. 6 and 7, the shaft SH2 is coupled to the gear G2 to overlap a rotation axis of the gear G2. However, the shaft SH2 is coupled to the gear G2 not to rotate in association with the rotation of the gear G2. This can be implemented, for example, by the shaft SH2 and the gear G2 being coupled via a bearing.

The transmission section TP1 may include a forward rotation preventing mechanism that transmits the rotation of the meshing gear PN1 to the rotating body RX1 in the movement of the paper feeding tray TR in the drawing-out direction and does not transmit the rotation of the meshing gear PN1 to the rotating body RX1 in the movement of the paper feeding tray TR in the attaching direction. The forward rotation preventing mechanism is, for example, a one-way clutch mechanism but is not limited to the one-way mechanism. When the forward rotation preventing mechanism is the one-way clutch mechanism, for example, the forward rotation preventing mechanism is provided to at least one of the rotating body RX1, the gears G1 to G4, and the meshing gear PN1. Accordingly, the paper feeding unit 10 can prevent the winding body RB from being rotated at the time of the movement in the attaching direction, that is, it is possible to suppress the roll paper RP from being released from the winding body RB when moving in the attaching direction. Accordingly, when the roll paper RP is let out from the winding body RB, the paper feeding unit 10 can convert the rotating body RX1 into a driven roller and can reduce a load on the winding body RB. This leads to suppression of deterioration in paper feeding accuracy and is useful.

The biasing section SG2 urges the rotating body RX1 toward the winding body RB. For this reason, for example, when setting the winding body RB in the paper feeding tray TR, the user sets the winding body RB in the paper feeding tray TR while moving the rotating body RX1 against an biasing force by the biasing section SG2. The biasing section SG2 is, for example, a torsion spring but is not limited to the torsion spring. Since the rotating section RT includes the biasing section SG2, the paper feeding unit 10 can increase a frictional force between the winding body RB and the rotating body RX1 and prevent failure in the rotation of the winding body RB by the rotating body RX1. Since the rotating section RT includes the biasing section SG2, the paper feeding unit 10 can press the winding body RB from the first contact surface side and, as a result, prevent the roll paper RP let out from the winding body RB from moving in the width direction. This leads to suppression of occurrence of deviation of position where printing is performed by the printing section PR and is useful.

As explained above, the paper feeding unit 10 rotates the winding body RB according to the drawing-out operation performed on the paper feeding tray TR by the user in order to move the paper feeding tray TR from the attachment position to the drawing-out position. Accordingly, the paper feeding unit 10 rotates the winding body RB in the reverse rotating direction when the roll paper RP is fed from the winding body RB to thereby cause the winding body RB to wind a part of the roll paper RP let out from the winding body RB. As a result, the paper feeding unit 10 can prevent the roll paper RP from bending when causing the winding body RB to wind the roll paper RP according to the drawing-out operation.

The paper feeding unit 10 may have a configuration in which the rotating section RT is provided on both a surface on the positive direction side of the Y axis of the paper feeding tray TR and a surface on the negative direction side of the Y axis of the paper feeding tray TR. The paper feeding unit 10 may have a configuration in which the rotating section RT is not provided on the surface on the positive direction side of the Y axis of the paper feeding tray TR and the rotating section RT is provided on the surface on the negative direction side of the Y axis of the paper feeding tray TR.

### Modification 1 of the First Embodiment

A modification 1 of the first embodiment is explained below. In the modification 1 of the first embodiment, the drawing-out operation is not operation of moving the paper feeding tray TR in the drawing-out direction but is operation on the knob NB. For this reason, in the modification 1 of the first embodiment, the paper feeding tray TR includes a rotating section RT2 instead of the rotating section RT.

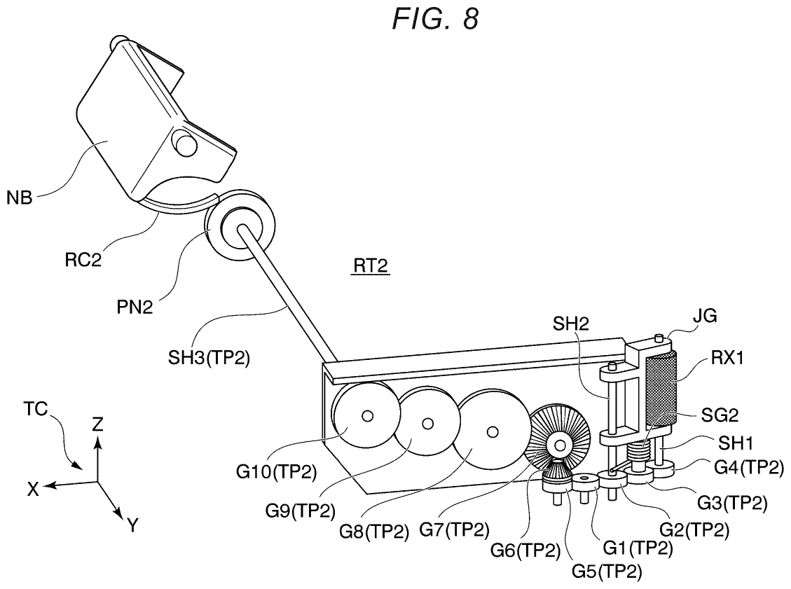

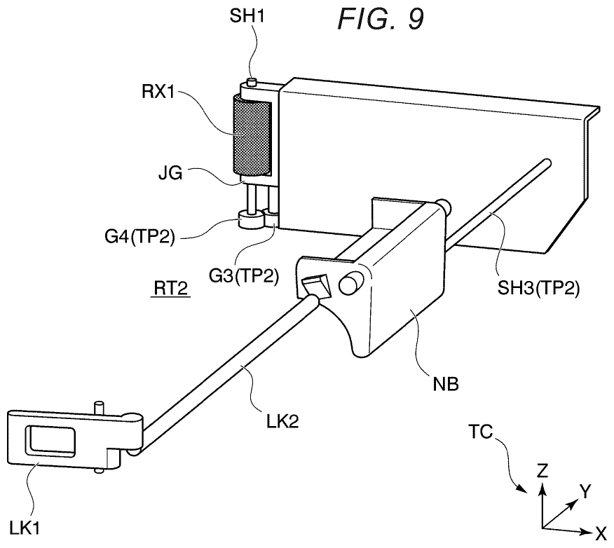

FIG. 8 is a perspective view illustrating an example of a configuration of the rotating section RT2 according to the modification 1 of the first embodiment. FIG. 9 is a perspective view in which the rotating section RT2 illustrated in FIG. 8 is viewed from another direction.

The rotating section RT2 includes, for example, the rotating body RX1, the jig JG, a rack RC2, a meshing gear PN2, a transmission section TP2, and an biasing section SG2. The rotating body RX1 according to the modification 1 of the first embodiment is an example of a second rotating body.

The rack RC2 is a rack provided in the knob NB. The rack RC2 meshes with the meshing gear PN2 and rotates the meshing gear PN2 in a process in which the user performs, on the knob NB, operation of releasing the lock of the paper feeding tray TR by the lock section LK. Here, in order to move the paper feeding tray TR in the drawing-out direction, it is necessary to release the lock of the paper feeding tray TR by the lock section LK by operating the knob NB. Therefore, the operation performed by the user on the knob NB in order to release the lock of the paper feeding tray TR by the lock section LK is an example of the drawing-out operation. In such drawing-out operation, the knob NB turns around a turning axis of the knob NB. The rack RC2 rotates the meshing gear PN2 simultaneously with the turning of the knob NB. For this reason, the rack RC2 is a curved rack as illustrated in FIG. 8. The rotation of the meshing gear PN2 is transmitted to the rotating body RX1 by the transmission section TP2. Therefore, the rack RC2 can rotate the rotating body RX1 via the transmission section TP2 by rotating the meshing gear PN2. As a result, the rack RC2 can rotate the winding body RB in the reverse rotating direction. For this reason, the rack RC2 is provided at a position where the rack RC2 is capable of meshing with the meshing gear PN2 in the process. The rack RC2 is provided not to mesh with the meshing gear PN2 when the paper feeding tray TR is locked by the lock section LK, that is, when the drawing-out operation is not performed. This is because, if the rack RC2 meshes with the meshing gear PN2 in this case, the rotating body RX1 sometimes hinders drawing-out of the roll paper RP from the winding body RB. That is, accordingly, the rack RC2 can prevent the rotating body RX1 from hindering the let-out of the roll paper RP from the winding body RB in this case. This leads to suppression of a load on the winding body RB and, as a result, leads to suppression of deterioration in paper feeding accuracy and is useful.

The meshing gear PN2 is a pinion capable of meshing with the rack RC2. The meshing gear PN2 is provided at a position where the meshing gear PN2 meshes with the rack RC2 in a process in which the user performs, on the knob NB, the operation of releasing the lock of the paper feeding tray TR by the lock section LK.

The transmission section TP2 transmits a motion of the knob NB, which has received the operation, to the rotating body RX1 to rotate the rotating body RX1. The transmission section TP2 includes, for example, a plurality of gears and transmits the motion of the knob NB to the rotating body RX1 with the plurality of gears. In the example illustrated in FIGS. 8 and 9, the transmission section TP2 includes ten gears of gears G1 to G10 and a shaft SH3. The gear G5 meshes with the gear G1 and transmits rotation of the gear G5 to the gear G1. The gear G6 that rotates together with the gear G5 is provided to the gear G5. For this reason, a rotation axis of the gear G5 overlaps a rotation axis of the gear G6. The gear G6 is a bevel gear. The gear G6 meshes with the gear G7 and transmits rotation of the gear G7 to the gear G5 rotating together with the gear G6. The gear G7 is a bevel gear. According to the meshing of the gear G6 and the gear G7, rotation around a rotation axis parallel to the Y axis by the gear G7 is converted into rotation around a rotation axis parallel to the Z axis by the gear G6. The outer circumference of the gear G7 around the rotation axis is formed as a gear that meshes with the gear G8. For this reason, the gear G7 meshes with each of the gear G6 and the gear G8 and transmits rotation of the gear G8 to the gear G6. The gear G8 meshes with each of the gear G7 and the gear G9 and transmits rotation of the gear G9 to the gear G7. The gear G9 meshes with each of the gear G10 and the gear G8 and transmits rotation of the gear G10 to the gear G8. The gear G10 meshes with the gear G9. The gear G10 is coupled to the meshing gear PN2 via the shaft SH3. The shaft SH3 couples the gear G10 and the meshing gear PN2 to respectively overlap a rotation axis of the gear G10 and a rotation axis of the meshing gear PN2. For this reason, the gear G10 rotates in association with the meshing gear PN2. That is, the gear G10 transmits the rotation of the meshing gear PN2 to the gear G9. With such a configuration, the transmission section TP2 transmits the rotation of the meshing gear PN2 to the rotating body RX1 with the ten gears to rotate the rotating body RX1.

The transmission section TP2 may include a forward rotation preventing mechanism that transmits the motion of the knob NB, which has received the operation of releasing the lock by the lock section LK, to the rotating body RX1 and does not transmit, to the rotating body RX1, a motion of the knob NB opposite to the motion of the knob NB in the operation of releasing the lock by the lock section LK. The forward rotation preventing mechanism is, for example, a one-way clutch mechanism but is not limited to the one-way mechanism. When the forward rotation preventing mechanism is the one-way clutch mechanism, for example, the forward rotation preventing mechanism is provided to at least a part of the rotating body RX1, the gears G1 to G10, and the meshing gear PN2. Accordingly, when the knob NB receives operation opposite to the operation of releasing the lock by the lock section LK, the paper feeding unit 10 can prevent the winding body RB from being rotated, that is, prevent the roll paper RP from being let out from the winding body RB when the operation is received. Accordingly, when the roll paper RP is let out from the winding body RB, the paper feeding unit 10 can convert the rotating body RX1 into a driven roller and can reduce a load on the winding body RB. The transmission section TP2 is an example of a second transmission section.

As explained above, even when the drawing-out operation is not the operation of moving the paper feeding tray TR in the drawing-out direction but is operation on the knob NB, the paper feeding unit 10 can rotate the winding body RB according to the drawing-out operation performed on the paper feeding tray TR by the user. As a result, the paper feeding unit 10 can prevent the roll paper RP from bending when causing the winding body RB to wind the roll paper RP according to the drawing-out operation. In this case, the paper feeding unit 10 can rotate the winding body RB without involving movement of the paper feeding tray TR in the drawing-out direction. This leads to preventing the roll paper RP let out from the winding body RB from coming into contact with the housing BX or the like to be deformed according to the movement of the paper feeding tray TR in the drawing-out direction and is useful.

### Modification 2 of the First Embodiment

Subsequently, a modification 2 of the first embodiment is explained. In the modification 2 of the first embodiment, the drawing-out operation is operation of moving the paper feeding tray TR in the drawing-out direction. In the modification 2 of the first embodiment, the paper feeding unit 10 includes a reverse conveyance section RC and a rotating section RT3 instead of the rotating section RT2.

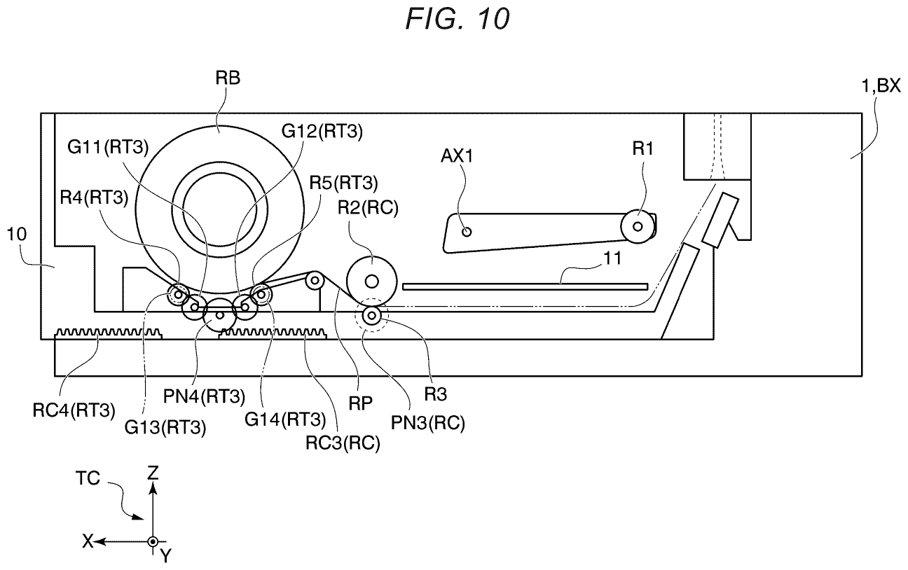

FIG. 10 is a side cross-sectional view illustrating an example of a configuration of each of the reverse conveyance section RC and the rotating section RT3 according to the modification 2 of the first embodiment.

The reverse conveyance section RC feeds the roll paper RP, which is let out from the winding body RB, toward the winding body RB in association with the movement of the paper feeding tray TR in the drawing-out direction. The reverse conveyance section RC includes a roller R2, a meshing gear PN3, and a rack RC3.

The roller R2 is rotatably supported by the paper feeding tray TR. The roller R2 comes into contact with the roll paper RP let out from the winding body RB. The roller R2 also comes into contact with a roller R3 provided in the meshing gear PN3. For this reason, the roller R2 rotates in association with the meshing gear PN3.

The meshing gear PN3 transmits a rotational force to the roller R2. As explained above, the roller R3 is provided in the meshing gear PN3 such that a rotation axis of the meshing gear PN3 and a rotation axis of the roller R3 overlap each other. For this reason, the roller R3 rotates together with the meshing gear PN3. The meshing gear PN3 meshes with the rack RC3 in a process in which the paper feeding tray TR moves from the attachment position to the drawing-out position. For this reason, the meshing gear PN3 rotates the roller R2 and the roller R3 by rotating according to the movement of the paper feeding tray TR in the drawing-out direction. By such rotation of the roller R2 and the roller R3, the roll paper RP sandwiched between the roller R2 and the roller R3 is fed toward the winding body RB. The meshing gear PN3 is an example of a first pinion. The rack RC3 is an example of a first rack.

Here, when the reverse conveyance section RC feeds the roll paper RP toward the winding body RB, the roll paper RP is about to wind around the winding body RB. However, if the winding body RB does not rotate in the reverse rotating direction in synchronization with the reverse conveyance section RC feeding the roll paper RP to the winding body RB, the roll paper RP sometimes bends in the periphery of the winding body RB. In order to suppress occurrence of such a bend, the paper feeding unit 10 includes a rotating section RT3 together with the reverse conveyance section RC.

The rotating section RT3 includes, for example, a roller R4, a roller R5, a gear G11, a gear G12, a rack RC4, and a meshing gear PN4.

Here, in the modification 2 of the first embodiment, the winding body RB is supported by two rollers of the roller R4 and the roller R5 instead of being supported by the target connecting portion and the winding body support part 11A explained above. Rotation axes of the two rollers are parallel to the rotation axis of the winding body RB. For this reason, the winding body RB rotates in association with rotation of the two rollers. That is, the two rollers rotate the winding body RB by rotating in a state of being in contact with the outer circumferential surface of the winding body RB in the direction orthogonal to the rotation axis of the winding body RB. For this reason, each of the two rollers is an example of a third rotating body.

The roller R4 is provided to a gear G13 such that a rotation axis of the roller R4 overlaps a rotation axis of the gear G13. For this reason, the roller R4 rotates together with the gear G13. The gear G13 meshes with the gear G11 and transmits rotation of the gear G11 to the roller R4. That is, the roller R4 transmits the rotation of the gear G11 to the winding body RB.

The roller R5 is provided to a gear G14 such that a rotation axis of the roller R5 overlaps a rotation axis of the gear G14. For this reason, the roller R5 rotates together with the gear G14. The gear G14 meshes with the gear G12 and transmits rotation of the gear G12 to the roller R5. That is, the roller R5 transmits the rotation of the gear G12 to the winding body RB.

The gear G11 meshes with the meshing gear PN4 and transmits rotation of the meshing gear PN4 to the roller R4. The gear G12 also meshes with the meshing gear PN4 and transmits the rotation of the meshing gear PN4 to the roller R5.

The meshing gear PN4 transmits the rotation to each of the gear G11 and the gear G12. The meshing gear PN4 meshes with the rack RC4 in the process in which the paper feeding tray TR moves from the attachment position to the drawing-out position. When the meshing gear PN4 meshes with the rack RC4, the meshing gear PN3 and the rack RC3 also mesh with each other. That is, in the paper feeding tray TR, the rack RC4 is provided such that meshing timing of the meshing gear PN4 and the rack RC4 and meshing timing of the meshing gear PN3 and the rack RC3 coincide or substantially coincide with each other. These timings may be shifted as long as the roll paper RP fed toward the winding body RB by the reverse conveyance section RC does not bend without being wound by the winding body RB. For this reason, in the paper feeding tray TR, the rack RC4 may be provided such that the meshing timing of the meshing gear PN4 and the rack RC4 and the meshing timing of the meshing gear PN3 and the rack RC3 substantially coincide with each other. Each of the gears G11 and G12 rotates when the meshing gear PN4 and the rack RC4 mesh with each other in this process and transmits rotation of the meshing gear PN4 to the winding body RB. Accordingly, the winding body RB rotates in the reverse rotating direction. In the paper feeding tray TR, since the meshing timing of the meshing gear PN4 and the rack RC4 and the meshing timing of the meshing gear PN3 and the rack RC3 coincide or substantially coincide with each other, the roll paper RP fed toward the winding body RB by the reverse conveyance section RC is wound by the winding body RB according to rotation of the winding body RB in the reverse rotating direction. Accordingly, the paper feeding unit 10 can prevent the roll paper from bending when causing the winding body to wind the roll paper according to the drawing-out operation. The meshing gear PN4 is an example of a second pinion. The rack RC4 is an example of a second rack.

The paper feeding unit 10 may have a configuration in which the winding body RB is rotated by a roller that is provided to be capable of turning around the rotation axis of the roller R2 and rotates at a position away from the rotation axis when the rotation of the roller R2 is transmitted thereto. In this case, the roller comes into contact with the winding body RB downward from above. In this case, the paper feeding unit 10 includes a mechanism that transmits the rotation of the roller R2 to the roller. In this case, the rotating section RT3 includes the roller and the mechanism. Even in this case, timing when the winding body RB starts to rotate in the reverse rotating direction and timing when the reverse conveyance section RC starts to feed the roll paper RP toward the winding body RB are the same or substantially the same. This is because the rotating the winding body RB in the reverse rotating direction and the reverse conveyance section RC starting to feed the roll paper RP toward the winding body RB are caused by rotation of the roller R2. It can be interpreted that the rack RC3 and the rack RC4 are integrally configured and the meshing gear PN3 and the meshing gear PN4 are integrally configured. It can also be considered that the configuration of the paper feeding unit 10 is simplified. The roller is an example of a fourth rotating body. In this case, the paper feeding unit 10 may include a pressing section that comes into contact with the outer circumferential surface of the winding body RB in the direction orthogonal to the rotation axis of the winding body RB and presses the winding body RB against the roller. In this case, the paper feeding unit 10 can increase a frictional force between the roller and the winding body RB and make it easy to rotate the winding body RB with the roller. In other words, in this case, the paper feeding unit 10 can prevent failure in rotation of the winding body RB by the roller. In the paper feeding unit 10 illustrated in FIG. 10, the rack RC3 may be integrated with the rack RC4.

As explained above, even when the paper feeding unit 10 includes the reverse conveyance section RC and the rotating section RT3 instead of the rotating section RT2, the paper feeding unit 10 can prevent the roll paper RP from bending when causing the winding body RB to wind the roll paper RP according to the drawing-out operation. The reverse conveyance section RC may be combined with the rotating section RT in the first embodiment or may be combined with the rotating section RT2 in the modification 1 of the first embodiment. In other words, the reverse conveyance section RC may be additionally applied to the first embodiment or may be additionally applied to the modification 1 of the first embodiment.

Each of the rotating section RT, the rotating section RT2, and the rotating section RT3 explained above is provided in the paper feeding tray TR not to come into contact with all of the one or more pieces of cut paper CP in the paper feeding tray TR. This is to, in addition unnecessity to draw back the cut papers CP, prevent an alignment property of the one or more pieces of cut paper CP stored in the paper feeding tray TR from being deteriorated.

As explained above, in each of the first embodiment, the modification 1 example of the first embodiment, and the modification 2 of the first embodiment, the paper feeding unit 10 can cause the winding body RB to wind, according to the drawing-out operation, a part of the roll paper RP let out from the winding body RB. However, it can also be considered that this means that the paper feeding unit 10 cannot cause the winding body RB to wind the entire roll paper RP let out from the winding body RB according to the drawing-out operation. Therefore, a user who is about to take out the winding body RB from the paper feeding unit 10 has to take out the winding body RB from the paper feeding unit 10 after performing the drawing-out operation and thereafter manually wind the roll paper RP let out from the winding body RB. In some case, this hinders improvement of the convenience of the user and is determined as undesirable. Thus, a printing apparatus 2 explained in a second embodiment has a configuration of being able to cause the winding body RB to easily wind back the roll paper RP to a desired state. The second embodiment of the present disclosure is explained below.

### Second Embodiment

The second embodiment of the present disclosure is explained below with reference to the drawings.

### Overview of the Printing Apparatus According to the Second Embodiment

First, an overview of the printing apparatus according to the second embodiment is explained.

The printing apparatus according to the second embodiment includes a paper feeding unit and a printing section. The paper feeding unit includes a paper feeding tray, an operation section, and a rotating section. The paper feeding tray refers to a tray capable of storing a winding body for roll paper. The operation section receives operation. The rotating section rotates the winding body in a reverse rotating direction opposite to a forward rotating direction, which is a rotating direction of the winding body at the time when the roll paper is let out from the winding body, according to the operation received by the operation section. Then, the printing section prints an image on the roll paper let out from the winding body stored in the paper feeding tray. Accordingly, the printing apparatus can cause the winding body to easily wind the roll paper to a desired state.

In the following explanation, a configuration of the printing apparatus according to the second embodiment is explained in detail.

### Configuration of the Printing Apparatus According to the Second Embodiment

The configuration of the printing apparatus according to the second embodiment is explained below taking the printing apparatus 2 as an example. However, the printing apparatus 2 has the same configuration as the configuration of the printing apparatus 1 except that the printing apparatus 2 includes a paper feeding unit 20 instead of the paper feeding unit 10. For this reason, in the second embodiment, a configuration of the paper feeding unit 20 is explained in detail. In the second embodiment, for convenience of explanation, a user of the printing apparatus 2 is simply referred to as user. In the second embodiment, the same components as the components in the first embodiment are denoted by the same reference numerals and signs and explanation of the components is omitted.

The paper feeding unit 20 includes the paper feeding tray TR, the lock section LK, an operation section CN1, and a rotating section RT4. Here, the paper feeding unit 20 has the same configuration as the configuration of the paper feeding unit 10 except that the paper feeding unit 20 includes the operation section CN1 and the rotating section RT4 instead of the rotating section RT. For this reason, in the second embodiment, detailed explanation about the configuration of the paper feeding unit 20 other than the operation section CN1 and the rotating section RT4 is omitted.

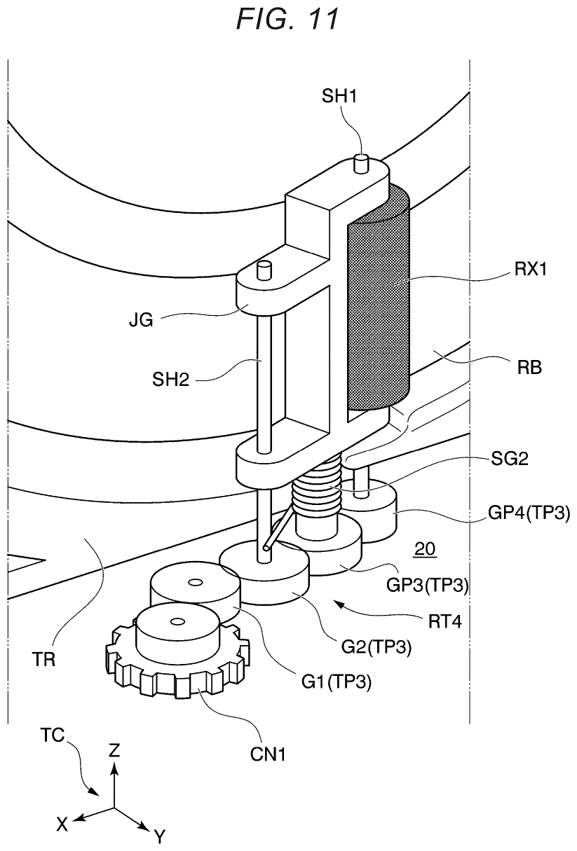

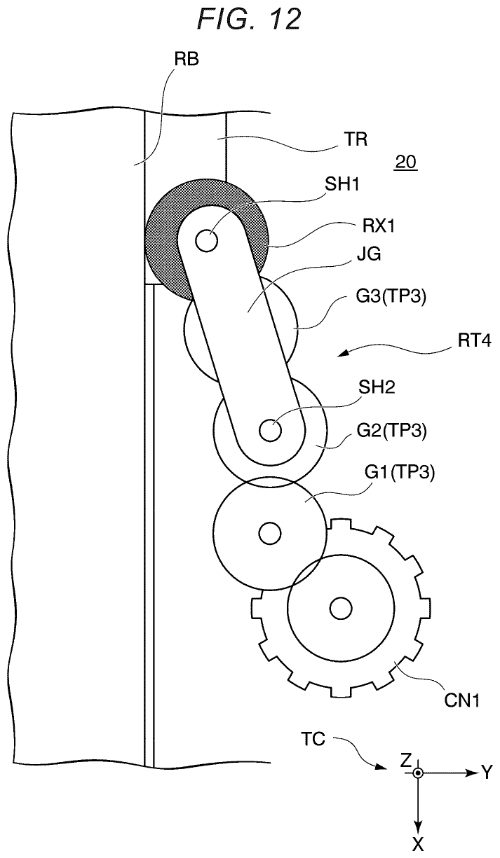

FIG. 11 is a perspective view illustrating an example of each of the operation section CN1 and the rotating section RT4 provided in the paper feeding unit 20. FIG. 12 is a top view of the operation section CN1 and the rotating section RT4 illustrated in FIG. 11.

The operation section CN1 may be any member if the member is a member that receives operation. In the example illustrated in FIGS. 11 and 12, the operation section CN1 is a dial. For this reason, in this example, the operation section CN1 is capable of rotating around a predetermined rotation axis. In this example, a gear having a rotation axis overlapping the rotation axis of the operation section CN1 is provided in the operation section CN1. For this reason, the gear rotates together with the operation section CN1. In the following explanation, as an example, a case is explained in which the rotation axis is an axis parallel to the Z axis as illustrated in FIGS. 11 and 12.

The operation section CN1 is provided at a front lower portion of the surface on the positive direction side of the Y axis among the surfaces of the paper feeding tray TR to be able to receive operation from the user. For this reason, for example, an opening through which the user can insert a hand in order to operate the operation section CN1 is formed in the housing BX. The opening may be closed or may not be closed by an open-closable cover or the like. The operation section CN1 may be provided at another position where operation from the user can be received among positions of the paper feeding tray TR.

The rotating section RT4 rotates the winding body RB in the reverse rotating direction according to the operation received by the operation section CN1. More specifically, when the operation section CN1 receives operation of rotating the operation section CN1 around the rotation axis in a predetermined first rotating direction, the rotating section RT4 rotates the winding body RB in the reverse rotating direction. In the example illustrated in FIGS. 11 and 12, the first rotating direction is a direction in which the operation section CN1 rotates counterclockwise when the operation section CN1 is viewed in a downward direction. Accordingly, the user can cause the winding body RB to wind the roll paper RP to a desired state by manually operating the operation section CN1.

The rotating section RT4 includes the rotating body RX1, the jig JG, a transmission section TP3, and an biasing section SG2.

The transmission section TP3 transmits a motion of the operation section CN1, which has received operation, to the rotating body RX1 to rotate the rotating body RX1. The transmission section TP3 includes, for example, a plurality of gears and transmits the motion of the operation section CN1 to the rotating body RX1 with the plurality of gears. In the example illustrated in FIGS. 11 and 12, the transmission section TP3 includes four gears of the gears G1 to G4. That is, in the second embodiment, the four gears configure the transmission section TP3. In the second embodiment, the gear G1 meshing with the meshing gear PN1 in the first embodiment meshes with a gear provided in the operation section CN1 instead of the meshing gear PN1 and transmits the motion of the operation section CN1, that is, rotation of the operation section CN1 to the gear G2. For this reason, the rotating body RX1 rotates in association with the rotation of the operation section CN1. As explained above, the transmission section TP3 transmits the motion of the operation section CN1 to the rotating body RX1 with the four gears to rotate the rotating body RX1. Therefore, the user can rotate the winding body RB in the reverse rotating direction by operating the operation section CN1. As a result, the user can cause the winding body RB to wind a part or the entire roll paper RP let out from the winding body RB. That is, the paper feeding unit 10 can cause the winding body RB to easily wind back the roll paper RP to a desired state. The transmission section TP3 is an example of a transmission section.

The transmission section TP3 may include a forward rotation preventing mechanism that prevents the winding body RB from rotating in the forward rotating direction in association with the motion of the operation section CN1. The forward rotation preventing mechanism is, for example, a one-way clutch mechanism but is not limited to the one-way mechanism. When the forward rotation preventing mechanism is the one-way clutch mechanism, for example, the forward rotation preventing mechanism is provided to at least one of the rotating body RX1, the gears G1 to G4, and the operation section CN1. Accordingly, the paper feeding unit 20 can prevent the user from erroneously rotating the winding body RB in the forward rotating direction, that is, prevent the user from erroneously causing the winding body RB to let out the roll paper RP. Accordingly, when the roll paper RP is let out from the winding body RB, the paper feeding unit 20 can convert the rotating body RX1 into a driven roller and can reduce a load on the winding body RB. This leads to suppression of deterioration in paper feeding accuracy and is useful.

As explained above, the paper feeding unit 20 rotates the winding body RB in the reverse rotating direction according to the operation received by the operation section CN1. Accordingly, the paper feeding unit 20 can cause the winding body RB to easily wind back the roll paper RP to a desired state.

The paper feeding unit 20 may have a configuration in which the operation section CN1 and the rotating section RT4 are provided on both of the surface on the positive direction side of the Y axis of the paper feeding tray TR and the surface on the negative direction side of the Y axis of the paper feeding tray TR. The paper feeding unit 10 may have a configuration in which the operation section CN1 and the rotating section RT4 are not provided on the surface on the positive direction side of the Y axis of the paper feeding tray TR and the operation section CN1 and the rotating section RT4 are provided on the surface on the negative direction side of the Y axis of the paper feeding tray TR.

### Modification 1 of the Second Embodiment

A modification 1 of the second embodiment is explained below. In the modification 1 of the second embodiment, the operation section CN1 is an operation section CN2 provided as a lever in a front surface lower portion of the paper feeding tray TR instead of the operation section CN1 that is the dial.

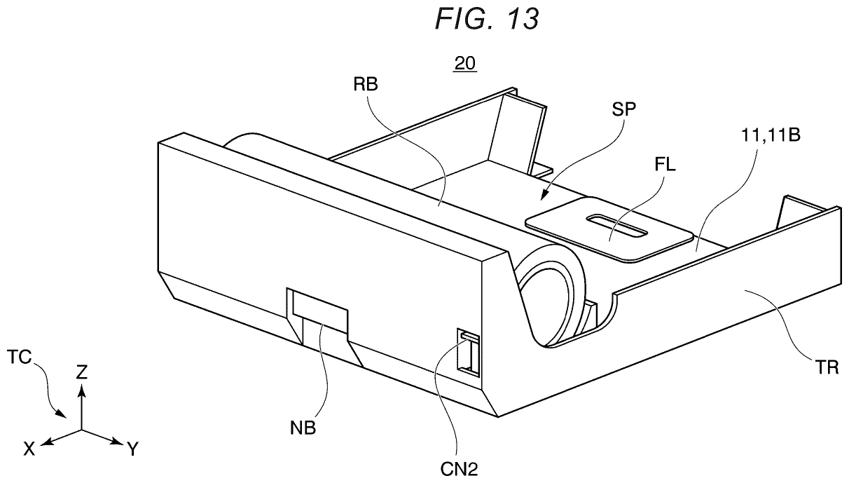

FIG. 13 is a diagram illustrating an example of a state in which the operation section CN2, which is the lever, is provided in the paper feeding tray TR. In the paper feeding unit 20 according to the modification 1 of the second embodiment, the user can rotate the winding body RB in the reverse rotating direction by moving the operation section CN2 illustrated in FIG. 13 up and down. The moving the operation section CN2 up and down means moving the operation section CN2 in parallel to the vertical direction.

In the modification 1 of the second embodiment, the paper feeding unit 20 includes the paper feeding tray TR, the lock section LK, the operation section CN2, and a rotating section RT5.

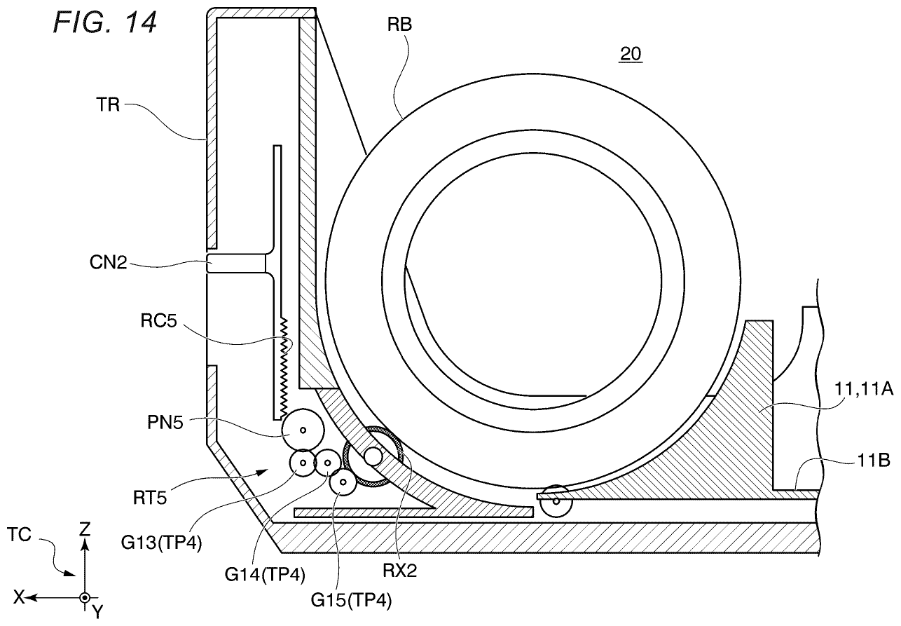

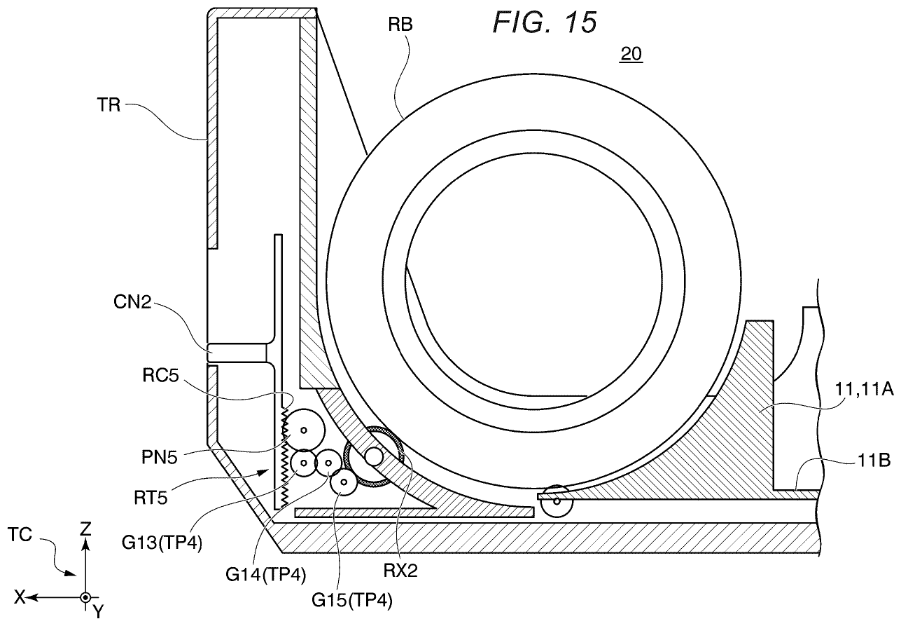

FIG. 14 is a perspective view illustrating an example of the rotating section RT5 in a state where the operation section CN2, which is the lever, is located at the uppermost position in the paper feeding tray TR. FIG. 15 is a perspective view illustrating an example of the rotating section RT5 in a state where the operation section CN2, which is the lever, is located at the lowermost position in the paper feeding tray TR

In the examples illustrated in FIGS. 14 and 15, the operation section CN2 is the lever that can be moved up and down as explained above. In this example, a rack RC5 that moves up and down together with the operation section CN2 is provided in the operation section CN2.

In the examples illustrated in FIGS. 14 and 15, the operation section CN2 is provided in the front surface lower portion of the paper feeding tray TR as explained above. However, this is merely an example and the operation section CN2 may be provided on another surface of the paper feeding tray TR, another position of the paper feeding tray TR, or the like.

The rotating section RT5 rotates the winding body RB in the reverse rotating direction according to operation received by the operation section CN2. More specifically, when the operation section CN2 receives operation of moving the operation section CN2 downward from above, the rotating section RT5 rotates the winding body RB in the reverse rotating direction. That is, this operation is operation of moving the operation section CN2 in the vertical direction.

The rotating section RT5 includes a rotating body RX2, a rack RC5, a meshing gear PN5, and a transmission section TP4.

The rotating body RX2 is a columnar object that rotates the winding body RB in the reverse rotating direction by rotating in a state of being in contact with the outer circumferential surface of the winding body RB in the direction parallel to the rotation axis of the winding body RB, and is, for example, a roller. In the examples illustrated in FIGS. 14 and 15, the rotating body RX2 rotates in a state of being in contact with a front lower portion of the winding body RB. Therefore, the rotating body RX2 is provided in the paper feeding tray TR to come into contact with the front lower portion of the winding body RB. In other words, the rotating body RX2 is provided at a target connecting portion to come into contact with the front lower portion of the winding body RB. For this reason, the rotating body RX2 is supported at the target connecting portion of the paper feeding tray TR to be capable of rotating around a rotation axis parallel to the rotation axis of the winding body RB. In this case, the winding body RB is supported by the rotating body RX2 and the winding body support part 11A in the space SP.

The rotating body RX2 is formed of a material having a high coefficient of friction such as rubber or elastomer. Accordingly, the paper feeding unit 20 can prevent failure in rotation of the winding body RB by the rotating body RX2. The rotating body RX2 may have a configuration in which only at least a part of the outer circumferential surface of the rotating body RX2 in the direction orthogonal to the rotation axis of the rotating body RX2 is formed of the material having a high coefficient of friction.

The rack RC5 is a rack provided in the operation section CN2 to move up and down together with the operation section CN2. The rack RC5 rotates the meshing gear PN5 by meshing with the meshing gear PN5 in a process in which the user moves the operation section CN2 downward from above. The rotation of the meshing gear PN5 is transmitted to the rotating body RX2 by the transmission section TP4. Accordingly, the rack RC5 can rotate the rotating body RX2 via the transmission section TP4 by rotating the meshing gear PN5. As a result, the rack RC5 can rotate the winding body RB in the reverse rotating direction. For this reason, the rack RC5 is provided at a position where the rack RC5 is capable of meshing with the meshing gear PN5 in this process. The rack RC5 is provided not to mesh with the meshing gear PN5 when the operation section CN2 is located at the uppermost position. This is because, if the rack RC5 meshes with the meshing gear PN5 in this case, the rotating body RX2 hinders the roll paper RP from being drawn out from the winding body RB. That is, accordingly, in this case, the rack RC5 can prevent the rotating body RX2 from hindering let-out of the roll paper RP from the winding body RB.

The meshing gear PN5 is a pinion capable of meshing with the rack RC5. The meshing gear PN5 is provided in the paper feeding tray TR.

The transmission section TP4 transmits rotation of the meshing gear PN5 to the rotating body RX2 to rotate the rotating body RX2. The transmission section TP4 includes, for example, a plurality of gears and transmits the rotation of the meshing gear PN5 to the rotating body RX2 with the plurality of gears. In the examples illustrated in FIGS. 14 and 15, the transmission section TP4 includes three gears of gears G13 to G15. The gear G13 meshes with each of the meshing gear PN5 and the gear G14 and transmits the rotation of the meshing gear PN5 to the gear G14. The gear G14 meshes with each of the gear G13 and the gear G15 and transmits rotation of the gear G13 to the gear G15. A roller having a rotation axis overlapping with a rotation axis of the gear G15 is provided to the gear G15. For this reason, the roller rotates together with the gear G15. The roller is in contact with the rotating body RX2 and transmits the rotation of the gear G15 to the rotating body RX2. For this reason, the rotating body RX2 rotates in association with an up-down movement of the operation section CN2. As explained above, the transmission section TP4 transmits the rotation of the meshing gear PN5 to the rotating body RX2 with the three gears to rotate the rotating body RX2.

The transmission section TP4 may include a forward rotation preventing mechanism that transmits the rotation of the meshing gear PN5 to the rotating body RX2 in an up to down movement of the operation section CN2 and does not transmit the rotation of the meshing gear PN5 to the rotating body RX2 in a down to up movement of the operation section CN2. The forward rotation preventing mechanism is, for example, a one-way clutch mechanism but is not limited to the one-way mechanism. When the forward rotation preventing mechanism is the one-way clutch mechanism, for example, the forward rotation preventing mechanism is provided to at least one of the rotating body RX2, the gears G13 to G15, and the meshing gear PN5. Accordingly, the paper feeding unit 20 can prevent the winding body RB from being rotated when the operation section CN2 is moved downward from above, that is, prevent the roll paper RP from being let out from the winding body RB when the operation section CN2 is moved upward from below. Accordingly, when the roll paper RP is let out from the winding body RB, the paper feeding unit 20 can convert the rotating body RX2 into a driven roller and can reduce a load on the winding body RB. This leads to suppression of deterioration in paper feeding accuracy and is useful.

As explained above, even when the paper feeding unit 20 includes the operation section CN2 instead of the operation section CN1, the paper feeding unit 20 rotates the winding body RB according to the operation received by the operation section CN2. Accordingly, the paper feeding unit 20 can cause the winding body RB to easily wind back the roll paper RP to a desired state.

### Modification 2 of the Second Embodiment

A modification 2 of the second embodiment is explained below. In the modification 2 of the second embodiment, the paper feeding unit 20 includes the rotating section RT2 explained in the modification 1 of the first embodiment instead of the rotating section RT5. However, in the modification 2 of the second embodiment, the transmission section TP2 of the rotating section RT2 includes a forward rotation preventing mechanism that transmits a motion of the knob NB that has received the operation of releasing the lock of the paper feeding tray TR by the lock section LK to the rotating body RX1 and does not transmit a motion of the knob NB that has received operation opposite to the operation of releasing the lock of the paper feeding tray TR by the lock section LK to the rotating body RX1. As explained above, the forward rotation preventing mechanism is, for example, a one-way clutch mechanism but is not limited to the one-way clutch mechanism. Because the transmission section TP2 includes the forward rotation preventing mechanism, the user can easily wind back the roll paper RP around the winding body RB to a desired state by repeatedly operating the knob NB. That is, the paper feeding unit 20 according to the modification 2 of the second embodiment can cause the winding body RB to easily wind back the roll paper RP to a desired state. Accordingly, the paper feeding unit 20 cause the user to perform, in one operation, the release of the lock of the paper feeding tray TR by the lock section LK and the winding of the roll paper RP around the winding body RB. This leads to improvement in usability and is useful. Since the configuration of the rotating section RT2 is illustrated in FIG. 8, the configuration is not illustrated again.

As explained above, since the paper feeding unit 20 includes the forward rotation preventing mechanism such as the one-way clutch mechanism together with the rotating section RT2, the paper feeding unit 20 can cause the winding body RB to easily wing back the roll paper RP to a desired state.

### Modification 3 of the Second Embodiment

A modification 3 of the second embodiment is explained below. In the modification 3 of the second embodiment, the paper feeding unit 20 includes an operation section CN3 instead of the operation section CN1.

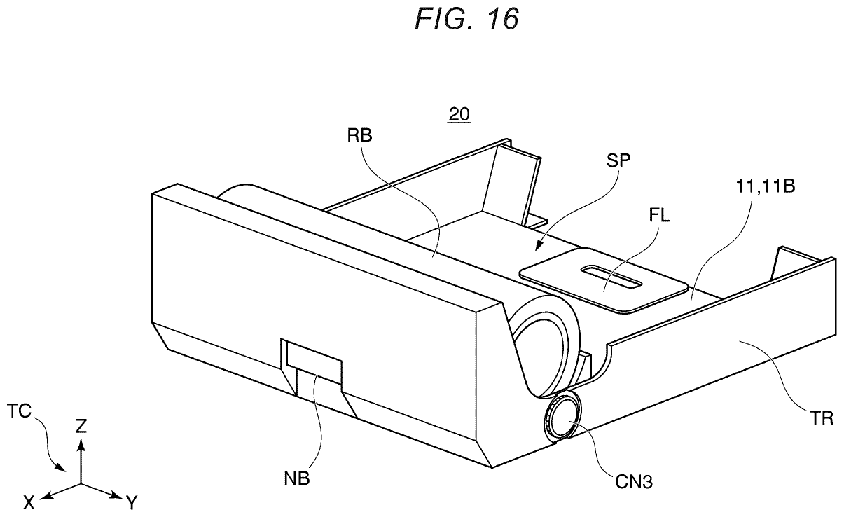

FIG. 16 is a perspective view illustrating an example of an exterior of the paper feeding unit 20 including the operation section CN3. As illustrated in FIG. 16, like the operation section CN1, the operation section CN3 is a dial. However, in the example illustrated in FIG. 16, unlike the operation section CN1 that is the dial capable of rotating around the rotation axis parallel to the Z axis, the operation section CN3 is a dial capable of rotating around a rotation axis parallel to the rotation axis of the winding body RB.

The operation section CN3 is provided in a front lower portion of the surface on the positive direction side of the Y axis among the surfaces of the paper feeding tray TR to be capable of receiving operation from the user. For this reason, for example, an opening through which the user can insert a hand in order to operate the operation section CN3 is formed in the housing BX. The opening may be closed or may not be closed by an open-closable cover or the like. The operation section CN3 may be provided at another position where operation from the user can be received among the positions of the paper feeding tray TR.

When the paper feeding unit 20 includes the operation section CN3, the paper feeding unit 20 includes a rotating section RT6 instead of the rotating section RT2.

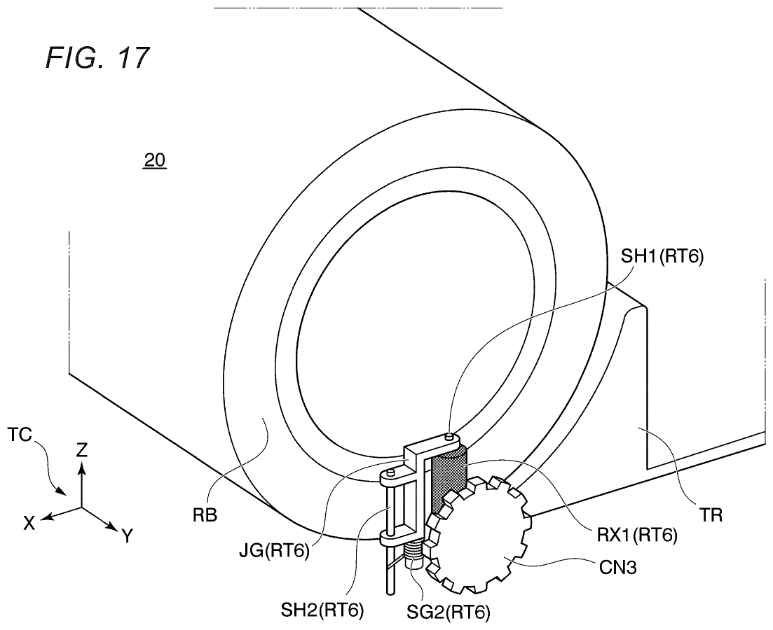

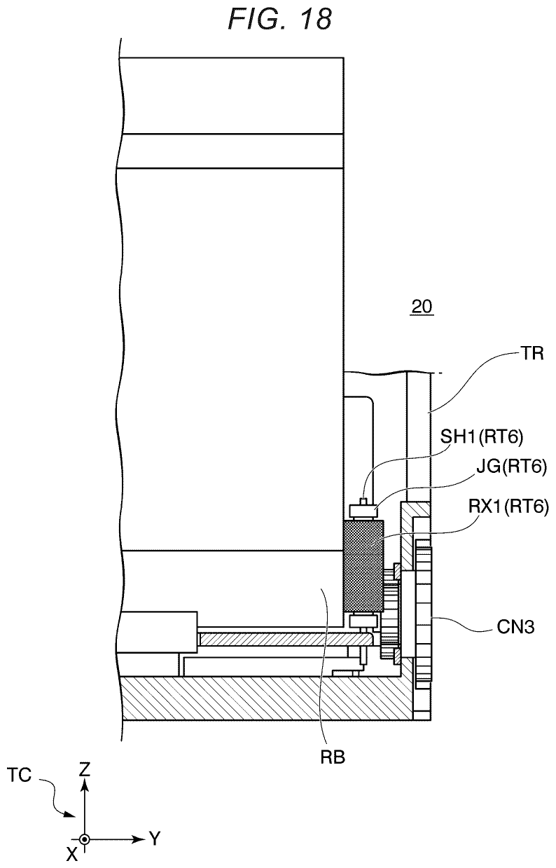

FIG. 17 is a perspective view illustrating an example of a configuration of the rotating section RT6. FIG. 18 is a front cross-sectional view of the rotating section RT6 illustrated in FIG. 17.

The rotating section RT6 includes, for example, the rotating body RX1, the jig JG, and the biasing section SG2. However, as illustrated in FIG. 18, the rotating body RX1 of the rotating section RT6 is in contact with an upper portion of a surface on the rotating body RX1 side among surfaces of the operation section CN3 and rotates in association with rotation around a rotation axis of the operation section CN3. At least one of the operation section CN3 and the rotating body RX1 includes a forward rotation preventing mechanism that, in rotation of the operation section CN3 in the case of rotating the winding body RB in the reverse rotating direction, transmits the rotation of the operation section CN3 to the rotating body RX1 and, in rotation of the operation section CN3 in the case of rotating the winding body RB in the forward rotating direction, does not transmit the rotation of the operation section CN3 to the rotating body RX1. The forward rotation preventing mechanism is, for example, a one-way clutch mechanism but is not limited to the one-way mechanism. Accordingly, the paper feeding unit 20 can prevent the operation section CN3 from rotating according to the rotation of the winding body RB in the case of the roll paper RP being let out from the winding body RB and can prevent the winding body RB from being rotated in the forward rotating direction according to operation on the operation section CN3. In this case, the user can easily wind back the roll paper RP around the winding body RB to a desired state by repeatedly operating the operation section CN3. That is, the paper feeding unit 20 according to the modification 3 of the second embodiment can cause the winding body RB to easily wind back the roll paper RP to a desired state. In the rotating section RT6 illustrated in FIGS. 17 and 18, instead of being the axis that is parallel to the Y axis, the rotation axis of the rotating body RX1 may be an axis nonparallel to the Y axis if the axis is an axis on which the rotating body RX1 is capable of coming into contact with the first contact surface.

As explained above, even when the paper feeding unit 20 includes the rotating section RT6 instead of the rotating section RT2, the paper feeding unit 20 can cause the winding body RB to easily wind back the roll paper RP to a desired state. In the rotating section RT6, the rotating body RX1 and the operation section CN3 may be integrally configured. In this case, the operation section CN3 can rotate, according to received operation, the winding body RB in the reverse rotating direction in a state of being in contact with the winding body RB. This leads to simplification of the configuration of the rotating section RT6 and, as a result, leads to a reduction in the size of the paper feeding unit 20 and is useful.

### Modification 4 of the Second Embodiment

A modification 4 of the second embodiment is explained below. In the modification 4 of the second embodiment, the paper feeding unit 20 includes an operation section CN4 and a rotating section RT7 instead of the operation section CN1 and the rotating section RT4.

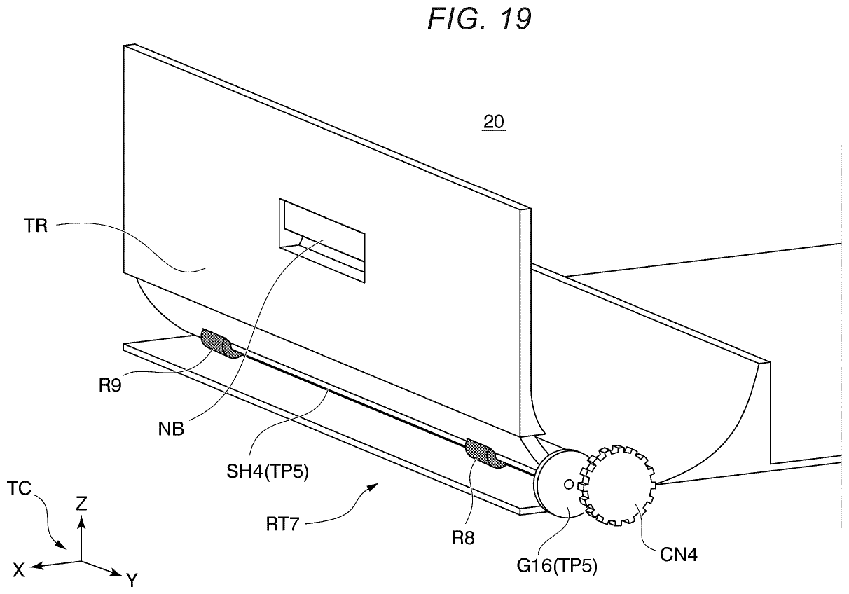

FIG. 19 is a diagram illustrating an example of a configuration of each of the operation section CN4 and the rotating section RT7 provided in the paper feeding unit 20.

Like the operation section CN3, the operation section CN4 is a dial capable of rotating around a rotation axis parallel to the rotation axis of the winding body RB. However, unlike the operation section CN3, a gear having a rotation axis overlapping with the rotation axis of the operation section CN4 is provided in the operation section CN4. That is, the gear rotates together with the operation section CN4.

The operation section CN4 is provided in a front lower portion of the surface on the positive direction side of the Y axis among the surfaces of the paper feeding tray TR to be capable of receiving operation from the user. For this reason, for example, an opening through which the user can insert a hand in order to operate the operation section CN4 is formed in the housing BX. The opening may be closed or may not be closed by an open-closable cover or the like. The operation section CN4 may be provided at another position where operation from the user can be received among the positions of the paper feeding tray TR.

The rotating section RT7 includes a roller R8, a roller R9, and a transmission section TP5.

Two rollers of the roller R8 and the roller R9 are rotatably supported in parallel to the rotation axis of the winding body RB in a target connecting portion and support the winding body RB. That is, the two rollers come into contact with the outer circumferential surface of the winding body RB in the direction orthogonal to the rotation axis of the winding body RB. For this reason, the winding body RB supported by the two rollers rotates in association with rotation of the two rollers. In addition to the two rollers, the rotating section RT7 may include one or more rollers that rotate together with the two rollers. In this case, together with the two rollers, the one or more rollers come into contact with the outer circumferential surface and support the winding body RB. The two rollers may be integrally configured as one roller. In this case, the one roller is a long roller extending in parallel to the rotation axis of the winding body RB.

The transmission section TP5 includes a shaft SH4 and a gear G16.

The shaft SH4 couples the roller R8, the roller R9, and the gear G16. Specifically, the shaft SH4 couples the roller R8, the roller R9, and the gear G16 to respectively overlap a rotation axis of the roller R8, a rotation axis of the roller R9, and a rotation axis of the gear G16. For this reason, the roller R8, the roller R9, and the gear G16 rotate in association with one another.

The gear G16 meshes with a gear provided in the operation section CN4 and transmits rotation of the operation section CN4 to each of the roller R8 and the roller R9. Therefore, the user can rotate the winding body RB by rotating the operation section CN4.

Here, the transmission section TP5 may include a forward rotation preventing mechanism that, in rotation of the operation section CN4 in the case of rotating the winding body RB in the reverse rotating direction, transmits the rotation of the operation section CN4 to the roller R8 and the roller R9 and, in rotation of the operation section CN4 in the case of rotating the winding body RB in the forward rotating direction, does not transmit the rotation of the operation section CN4 to the roller R8 and the roller R9. The forward rotation preventing mechanism is, for example, a one-way clutch mechanism but is not limited to the one-way mechanism. When the forward rotation preventing mechanism is the one-way clutch mechanism, for example, the forward rotation preventing mechanism is provided to at least one of the operation section CN4, the gear G16, and a combination of the roller R8 and the roller R9. Accordingly, the paper feeding unit 20 can prevent the operation section CN4 from rotating according to rotation of the winding body RB in the case in which the roll paper RP is let out from the winding body RB and can prevent the winding body RB from being rotated in the forward rotating direction according to operation of the operation section CN4. In this case, the user can easily wind back the roll paper RP around the winding body RB to a desired state by repeatedly operating the operation section CN4. That is, the paper feeding unit 20 according to the modification 4 of the second embodiment can easily wind back the roll paper RP around the winding body RB to a desired state. In addition, in the paper feeding unit 20 according to the modification 4 of the second embodiment, the roller R8 and the roller R9 can rotate the winding body RB on both of the positive direction side and the negative direction side of the Y axis of the outer circumferential surface of the winding body RB according to the operation on the operation section CN4. For this reason, the paper feeding unit 20 according to the modification 4 of the second embodiment can more securely rotate the entire outer circumferential surface of the winding body RB compared with when the winding body RB is rotated on one side of the outer circumferential surface of the winding body RB.

Modification 5 of the second embodiment

A modification 5 of the second embodiment is explained below. In the modification 5 of the second embodiment, the paper feeding unit 20 includes the operation section CN4 and a rotating section RT8 instead of the operation section CN1.

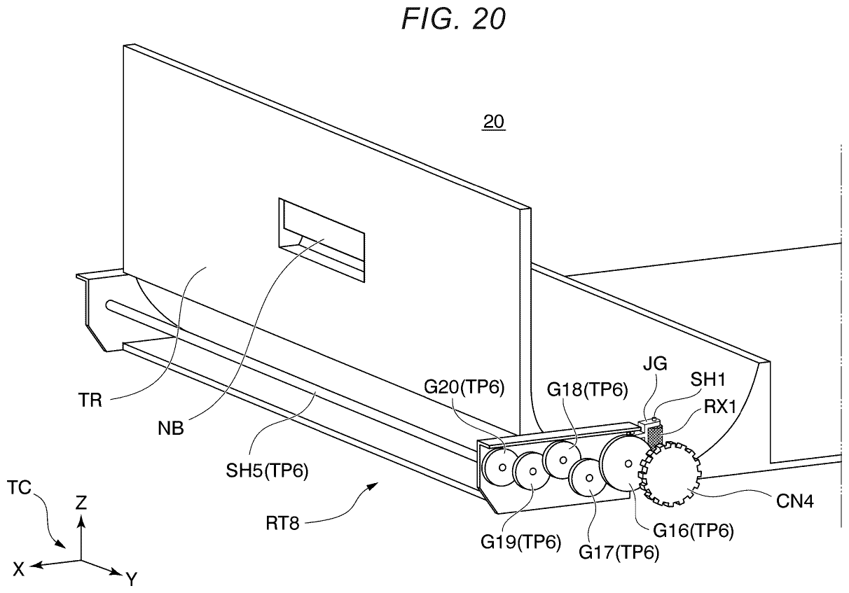

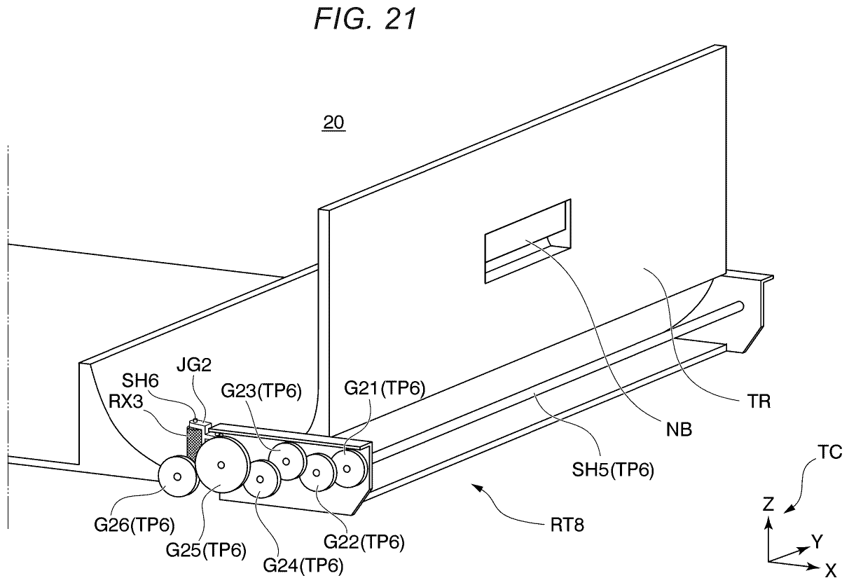

FIG. 20 is a diagram illustrating an example of a configuration of each of the operation section CN4 and the rotating section RT8 provided in the paper feeding unit 20. FIG. 21 is a perspective view in which each of the operation section CN4 and the rotating section RT8 illustrated in FIG. 20 is viewed from another direction.

The rotating section RT8 includes the rotating body RX1, a rotating body RX3, and a transmission section TP6.

The rotating body RX3 is a columnar object that rotates the winding body RB in the reverse rotating direction by rotating in a state of being in contact with the second end portion of the winding body RB, and is, for example, a roller. The rotating body RX3 is rotatably supported by a shaft SH6 supported by the jig JG2. In the example illustrated in FIG. 21, the rotating body RX3 is capable of coming into contact with a surface located below the rotation axis of the winding body RB among surfaces of the second end portion. In the following explanation, for convenience of explanation, the surface is referred to as second contact surface.

The rotating body RX3 is formed of a material having a high coefficient of friction such as rubber or elastomer. Accordingly, the paper feeding unit 20 can prevent failure in the rotation of the winding body RB by the rotating body RX3. The rotating body RX3 may have a configuration in which at least a part of the outer circumferential surface of the rotating body RX1 in a direction orthogonal to the rotation axis of the rotating body RX3 is formed of a material having a high coefficient of friction.

The transmission section TP6 includes eleven gears of gears G16 to G26 and a shaft SH5.

The gear G17 meshes with each of the gear G16 and the gear G18 and transmits rotation of the gear G16 to the gear G18. The gear G18 meshes with each of the gear G17 and the gear G19 and transmits rotation of the gear G17 to the gear G19. The gear G19 meshes with each of the gear G18 and the gear G20 and transmits rotation of the gear G18 to the gear G20. Accordingly, rotation of the operation section CN4 is transmitted to the gear G20 via the gears G16 to G19. Here, each of the gears G16 to G20 is provided on the surface on the positive direction side of the Y axis among the surfaces of the paper feeding tray TR. On the other hand, each of the gears G21 to G26 is provided on the surface on the negative direction side of the Y axis among the surfaces of the paper feeding tray TR. The gear G20 and the gear G21 are coupled by the shaft SH5 to rotate in association with each other. That is, the shaft SH5 couples the gear G20 and the gear G21 to respectively overlap a rotation axis of the gear G20 and a rotation axis of the gear G21.

The gear G21 meshes with the gear G22. The gear G22 meshes with each of the gear G21 and the gear G23 and transmits rotation of the gear G21 to the gear G23. The gear G23 meshes with each of the gear G22 and the gear G24 and transmits rotation of the gear G22 to the gear G24. The gear G24 meshes with each of the gear G23 and the gear G25 and transmits rotation of the gear G23 to the gear G25. The gear G25 meshes with each of the gear G24 and the gear G26 and transmits rotation of the gear G24 to the gear G26. An upper portion of a surface on the rotating body RX3 side among surfaces of the gear G26 is in contact with the rotating body RX3 in the same manner as a manner of the operation section CN3 being in contact with the rotating body RX1 illustrated in FIG. 18. Accordingly, the rotation of the gear G21 is transmitted to the rotating body RX3 via each of the gears G22 to G26. That is, the rotation of the operation section CN4 is transmitted to the rotating body RX3 via each of the gears G16 to G26 and the shaft SH5. For this reason, the user can rotate the winding body RB by rotating the operation section CN4.

Here, the transmission section TP6 may include a forward rotation preventing mechanism that, in rotation of the operation section CN4 in the case of rotating the winding body RB in the reverse rotating direction, transmits the rotation of the operation section CN4 to each of the rotating body RX1 and the rotating body RX3 and, in rotation of the operation section CN4 in the case of rotating the winding body RB in the forward rotating direction, does not transmit the rotation of the operation section CN4 to each of the rotating body RX1 and the rotating body RX3. The forward rotation preventing mechanism is, for example, a one-way clutch mechanism but is not limited to the one-way mechanism. When the forward rotation preventing mechanism is the one-way clutch mechanism, for example, the forward rotation preventing mechanism is provided to at least one of the rotating body RX1, the operation section CN4, and the gears G16 to G20 and is provided to at least one of the gears G21 to G26 and the rotating body RX3. Accordingly, the paper feeding unit 20 can prevent the operation section CN4 from rotating according to rotation of the winding body RB in the case in which the roll paper RP is let out from the winding body RB and can prevent the winding body RB from being rotated in the forward rotating direction according to operation of the operation section CN4. In this case, the user can easily wind back the roll paper RP around the winding body RB to a desired state by repeatedly operating the operation section CN4. That is, the paper feeding unit 20 according to the modification 5 of the second embodiment can easily wind back the roll paper RP around the winding body RB to a desired state. The paper feeding unit 20 according to the modification 5 of the second embodiment rotates the winding body RB from each of the first end portion and the second end portion of the winding body RB according to the operation on the operation section CN4. Therefore, the paper feeding unit 20 can easily rotate the entire winding body RB compared with when one of the first end portion and the second end portion of the winding body RB rotates the winding body RB. The paper feeding unit 20 according to the modification 5 of the second embodiment rotates the winding body RB from each of the first end portion and the second end portion of the winding body RB according to the operation on the operation section CN4. Therefore, the paper feeding unit 20 can more securely prevent a bend from occurring in the roll paper RP wound by the winding body RB because of fluctuation in the rotation of the winding body RB compared with when one of the first end portion and the second end portion of the winding body RB rotates the winding body RB.

The matters explained above may be combined in any way.

Each of the rotating bodies RX1 to RX3 explained above may include a plurality of rollers or may include a single roller.

Each of the operation section CN1, the operation section CN3, and the operation section CN4 explained above may be operable by a member such as a dial provided in the housing BX. In this case, the housing BX includes a mechanism that is coupled to each of the operation section CN1, the operation section CN3, and the operation section CN4 when the paper feeding unit 20 is attached to the housing BX and transmits a motion of the member to each of the operation section CN1, the operation section CN3, and the operation section CN4.

Each of the operation section CN1, the operation section CN3, and the operation section CN4 explained above may be rotated by an actuator. In this case, a button or the like for operating the actuator is provided in the paper feeding unit 20 or the housing BX.

The paper feeding unit 20 explained above may include a detection section that detects that the entire roll paper RP let out from the winding body RB has been wound by the winding body RB. In this case, the paper feeding unit 20 or the housing BX includes an informing section that informs that the detection section has detected that the entire roll paper RP has been wound by the winding body RB. The informing section is, for example, a light emitting diode (LED) but is not limited to the LED. The detection section may be, for example, a contact sensor that detects contact with the roll paper RP or may be another sensor.

The paper feeding unit 20 explained above may include a mechanism that rotates the winding body RB in the reverse rotating direction regardless of how each of the operation sections CN1 to CN4 is operated. The mechanism is, for example, a mechanism that switches gears that mesh with each other according to a rotating direction of the operation section CN1 but is not limited to the mechanism.

In the paper feeding unit 10 and the paper feeding unit 20 explained above, when the winding body RB is stored in the paper feeding tray TR, the user puts the winding body RB in the paper feeding tray TR after avoiding the rotating body with a hand. However, the paper feeding unit 10 and the paper feeding unit 20 explained above may include a mechanism that, in the paper feeding tray TR in which the winding body RB is not stored, separates the rotating body from a region where the winding body RB is stored and, in the paper feeding tray TR in which the winding body RB is stored, brings the rotating body into contact with the winding body RB.

### Appendix 1

[1]

A paper feeding unit including: a paper feeding tray capable of storing a winding body for roll paper; an operation section configured to receive operation; and a rotating section configured to rotate, according to the operation received by the operation section, the winding body in a reverse rotating direction opposite to a forward rotating direction that is a rotating direction of the winding body in a case in which the roll paper is let out from the winding body.

[2]

The paper feeding unit described in [1], wherein the operation section is capable of rotating around a predetermined rotation axis, and the rotating section rotates the winding body in the reverse rotating direction according to rotation of the operation section in a first rotating direction.

[3]

The paper feeding unit described in [1], further including a lock section configured to lock the paper feeding tray located at a predetermined attachment position with respect to a housing that supports, between the predetermined attachment position and a predetermined drawing-out position, the paper feeding tray to be capable of sliding in parallel to a predetermined drawing-out direction, wherein the attachment position is a position where the roll paper is let out from the paper feeding tray by a printing apparatus among positions to which the paper feeding tray is capable of sliding in the housing, the drawing-out position is a position a predetermined distance separated from the attachment position in the drawing-out direction among the positions to which the paper feeding tray is capable of sliding in the housing, the operation section is a knob that receives operation of releasing the lock to the housing by the lock section, and the rotating section rotates the winding body in the reverse rotating direction when the knob receives the operation of releasing the lock to the housing by the lock section.

[4]

The paper feeding unit described in [1], wherein the operation section includes a lever capable of moving in parallel to a predetermined first direction, and the rotating section rotates the winding body in the reverse rotating direction when the operation section receives operation of moving the lever in the first direction.

[5]

The paper feeding unit described in any one of [1] to [4], wherein the rotating section includes: one or more rotating bodies configured to rotate, in association with a motion of the operation section, the winding body in the reverse rotating direction in a state of being in contact with the winding body; and a transmission section configured to transmit the motion of the operation section to the one or more rotating bodies.

[6]

The paper feeding unit described in [5], wherein the one or more rotating bodies rotate the winding body in the reverse rotating direction in a state of being in contact with an outer circumferential surface of the winding body in a direction orthogonal to a rotation axis of the winding body.

[7]

The paper feeding unit described in [5], wherein the one or more rotating bodies include a first roller configured to rotate the winding body in the reverse rotating direction in a state of being in contact with a first end portion of both ends of the winding body in a direction parallel to a rotation axis of the winding body.

[8]

The paper feeding unit described in [7], wherein the one or more rotating bodies include a second roller configured to rotate the winding body in the reverse rotating direction in a state of being in contact with a second end portion of both the ends, and the transmission section transmits the motion of the operation section to each of the first roller and the second roller.

[9]

The paper feeding unit described in [1] or [2], wherein the operation section is configured integrally with the rotating section and rotates, according to the received operation, the winding body in the reverse rotating direction in a state of being in contact with the winding body.

The paper feeding unit described in any one of [1] to [9], wherein the rotating section includes a forward rotation preventing mechanism configured to prevent the winding body from rotating in the forward rotating direction in association with the motion of the operation section.

The paper feeding unit described in any one of [1] to [10], wherein the paper feeding tray is capable of storing one or more pieces of cut paper.

The paper feeding unit described in [11], wherein a region where the winding body is disposed in the paper feeding tray overlaps at least a part of a region where the one or more pieces of cut paper are disposed in the paper feeding tray.

[13]

[1] A printing apparatus including: the paper feeding unit described in any one of [1] to [12]; and a printing section configured to print an image on the roll paper let out from the winding body stored in the paper feeding tray.

The printing apparatus described in [13], further including a cutting section configured to cut the roll paper.

### Appendix 2

[1]

A paper feeding unit including: a paper feeding tray that is supported, between a predetermined attachment position and a predetermined drawing-out position, by a housing to be capable of sliding in parallel to a predetermined drawing-out direction and is capable of storing a winding body for roll paper; and a rotating section configured to rotate the winding body according to drawing-out operation of moving the paper feeding tray from the attachment position to the drawing-out position, wherein the attachment position is a position where the roll paper is let out from the paper feeding tray by a printing apparatus among positions to which the paper feeding tray is capable of sliding in the housing, the drawing-out position is a position a predetermined distance separated from the attachment position in the drawing-out direction among the positions to which the paper feeding tray is capable of sliding in the housing, and the rotating section causes, by rotating the winding body in a reverse rotating direction opposite to a forward rotating direction that is a rotating direction of the winding body in a case in which the roll paper is let out from the winding body, the winding body to wind a part of the roll paper let out from the winding body.

[2]

The paper feeding unit described in [1], wherein the rotating section is capable of coming into contact with a first end portion of both ends of the winding body in a direction parallel to a rotation axis of the winding body.

[3]

The paper feeding unit described in [2], wherein the rotating section includes: a first rotating body configured to rotate the winding body in the reverse rotating direction in a state of being in contact with the first end portion; a rack provided in one of the paper feeding tray and the housing; a meshing gear provided in another of the paper feeding tray and the housing and capable of meshing with the rack; and a first transmission section configured to transmit rotation of the meshing gear to the first rotating body to rotate the first rotating body.

[4]

The paper feeding unit described in [3], wherein the rack is provided in the housing, and the first rotating body and the meshing gear are provided in the paper feeding tray.

[5]

The paper feeding unit described in [3] or [4], wherein the first transmission section includes a forward rotation preventing mechanism configured to transmit the rotation of the meshing gear to the first rotating body in movement of the paper feeding tray in the drawing-out direction and not to transmit the rotation of the meshing gear to the first rotating body in movement of the paper feeding tray in an attaching direction opposite to the drawing-out direction.

[6]

The paper feeding unit described in any one of [3] to [5], wherein the rack does not mesh with the meshing gear when the paper feeding tray is located at the attachment position.

[7]

The paper feeding unit described in any one of [3] to [6], wherein the rotating section includes an biasing section configured to urge the first rotating body toward the winding body.

[8]

The paper feeding unit described in [2], further including: a lock section configured to lock the paper feeding tray located at the attachment position to the housing; and a knob configured to receive operation of releasing the lock to the housing by the lock section, wherein the rotating section includes: a second rotating body configured to rotate the winding body in the reverse rotating direction in a state of being in contact with the first end portion; and a second transmission section configured to transmit a motion of the knob, which received the operation, to the second rotating body to rotate the second rotating body.

[9]

The paper feeding unit described in [8], wherein the second transmission section includes a forward rotation preventing mechanism configured to transmit a motion of the knob, which received the operation of releasing the lock, to the second rotating body and not to transmit a motion of the knob, which is opposite to the motion of the knob in the operation of releasing the lock, to the second rotating body.

[10]

The paper feeding unit described in [8] or [9], wherein the rotating section includes an biasing section configured to urge the second rotating body toward the winding body.

[11]

The paper feeding unit described in [1], further comprising a reverse conveyance section configured to feed the roll paper, which is let out from the winding body, toward the winding body in association with the movement of the paper feeding tray in the drawing-out direction, wherein the rotating section starts to rotate the winding body in the reverse rotating direction simultaneously or substantially simultaneously with a start of the feeding of the roll paper by the reverse conveyance section.

[12]

The paper feeding unit described in [11], wherein the reverse conveyance section includes: a roller rotatably supported by the paper feeding tray and configured to come into contact with the roll paper let out from the winding body; a first pinion configured to transmit a rotational force to the roller; and a first rack provided in the housing and configured to mesh with the first pinion according to the movement of the paper feeding tray in the drawing-out direction and rotate the first pinion.

[13]

The paper feeding unit described in [11] or [12], wherein the rotating section includes: a third rotating body configured to rotate the winding body in the reverse rotating direction in a state of being in contact with an outer circumferential surface of the winding body in a direction orthogonal to a rotation axis of the winding body; a second pinion provided in the paper feeding tray and configured to transmit a rotational force to the third rotating body; and a second rack provided in the housing and configured to mesh with the second pinion according to the movement of the paper feeding tray in the drawing-out direction and rotate the second pinion.

[14]

The paper feeding unit described in [12], wherein the rotating section includes: a third rotating body configured to rotate the winding body in the reverse rotating direction in a state of being in contact with an outer circumferential surface of the winding body in a direction orthogonal to a rotation axis of the winding body; a second pinion provided in the paper feeding tray and configured to transmit a rotational force to the third rotating body; and a second rack provided in the housing and configured to mesh with the second pinion according to the movement of the paper feeding tray in the drawing-out direction and rotate the second pinion, and the second pinion meshes with the second rack when the first pinion and the first rack mesh with each other.

[15]

The paper feeding unit described in [12], wherein the rotating section includes: a fourth rotating body configured to rotate the winding body in the reverse rotating direction in a state of being in contact with an outer circumferential surface of the winding body in a direction orthogonal to a rotation axis of the winding body; a second pinion provided in the paper feeding tray and configured to transmit a rotational force to the fourth rotating body; and a second rack provided in the housing and configured to mesh with the second pinion according to the movement of the paper feeding tray in the drawing-out direction and rotate the second pinion, and the second rack is configured integrally with the first rack.

[16]

The paper feeding unit described in any one of [13] to [15], further including a pressing section configured to come into contact with an outer circumferential surface of the winding body in a direction orthogonal to a rotation axis of the winding body and press the winding body against the third rotating body.

[17]

A printing apparatus including: the paper feeding unit described in any one of

[1] to [12]; and a printing section, wherein the paper feeding tray is capable of storing each of the winding body and one or more pieces of cut paper, and the printing section prints an image on the roll paper let out from the winding body stored in the paper feeding tray or the cut paper.

[18]

The printing apparatus described in [17], wherein the rotating section comes into contact with none of the one or more pieces of cut paper.

[19]

The printing apparatus described in [17] or [18], further including a cutting section configured to cut the roll paper.

Although the embodiments of the present disclosure are explained in detail above with reference to the drawings, a specific configuration is not limited to the embodiments and may be, for example, changed, replaced, or deleted without departing from the gist of the present disclosure.

What is claimed is:

1. A paper feeding unit comprising:
a paper feeding tray that is supported, between a predetermined attachment position and a predetermined drawing-out position, by a housing to be capable of sliding in parallel to a predetermined drawing-out direction and is capable of storing a winding body for roll paper; and
a rotating section configured to rotate the winding body according to drawing-out operation of moving the paper feeding tray from the attachment position to the drawing-out position, wherein
the attachment position is a position where the roll paper is let out from the paper feeding tray by a printing apparatus among positions to which the paper feeding tray is capable of sliding in the housing,
the drawing-out position is a position a predetermined distance separated from the attachment position in the drawing-out direction among the positions to which the paper feeding tray is capable of sliding in the housing, and
the rotating section causes, by rotating the winding body in a reverse rotating direction opposite to a forward rotating direction that is a rotating direction of the winding body in a case in which the roll paper is let out from the winding body, the winding body to wind a part of the roll paper let out from the winding body.

2. The paper feeding unit according to claim 1, wherein the rotating section is capable of coming into contact with a first end portion of both ends of the winding body in a direction parallel to a rotation axis of the winding body.

3. The paper feeding unit according to claim 2, wherein the rotating section includes:
a first rotating body configured to rotate the winding body in the reverse rotating direction in a state of being in contact with the first end portion;
a rack provided in one of the paper feeding tray and the housing;
a meshing gear provided in another of the paper feeding tray and the housing and capable of meshing with the rack; and
a first transmission section configured to transmit rotation of the meshing gear to the first rotating body to rotate the first rotating body.

4. The paper feeding unit according to claim 3, wherein
the rack is provided in the housing, and
the first rotating body and the meshing gear are provided in the paper feeding tray.

5. The paper feeding unit according to claim 3, wherein the first transmission section includes a forward rotation preventing mechanism configured to transmit the rotation of the meshing gear to the first rotating body in movement of the paper feeding tray in the drawing-out direction and not to transmit the rotation of the meshing gear to the first rotating body in movement of the paper feeding tray in an attaching direction opposite to the drawing-out direction.

6. The paper feeding unit according to claim 3, wherein the rack does not mesh with the meshing gear when the paper feeding tray is located at the attachment position.

7. The paper feeding unit according to claim 3, wherein the rotating section includes an biasing section configured to urge the first rotating body toward the winding body.

8. The paper feeding unit according to claim 2, further comprising:
a lock section configured to lock the paper feeding tray located at the attachment position to the housing; and
a knob configured to receive operation of releasing the lock to the housing by the lock section, wherein
the rotating section includes:
a second rotating body configured to rotate the winding body in the reverse rotating direction in a state of being in contact with the first end portion; and
a second transmission section configured to transmit a motion of the knob, which received the operation, to the second rotating body to rotate the second rotating body.

9. The paper feeding unit according to claim 8, wherein the second transmission section includes a forward rotation preventing mechanism configured to transmit a motion of the knob, which received the operation of releasing the lock, to the second rotating body and not to transmit a motion of the knob, which is opposite to the motion of the knob in the operation of releasing the lock, to the second rotating body.

10. The paper feeding unit according to claim 8, wherein the rotating section includes an biasing section configured to urge the second rotating body toward the winding body.

11. The paper feeding unit according to claim 1, further comprising a reverse conveyance section configured to feed the roll paper, which is let out from the winding body, toward the winding body in association with the movement of the paper feeding tray in the drawing-out direction, wherein
the rotating section starts to rotate the winding body in the reverse rotating direction simultaneously or substantially simultaneously with a start of the feeding of the roll paper by the reverse conveyance section.

12. The paper feeding unit according to claim 11, wherein the reverse conveyance section includes:
a roller rotatably supported by the paper feeding tray and configured to come into contact with the roll paper let out from the winding body;
a first pinion configured to transmit a rotational force to the roller; and
a first rack provided in the housing and configured to mesh with the first pinion according to the movement of the paper feeding tray in the drawing-out direction and rotate the first pinion.

13. The paper feeding unit according to claim 11, wherein the rotating section includes:
a third rotating body configured to rotate the winding body in the reverse rotating direction in a state of being in contact with an outer circumferential surface of the winding body in a direction orthogonal to a rotation axis of the winding body;
a second pinion provided in the paper feeding tray and configured to transmit a rotational force to the third rotating body; and
a second rack provided in the housing and configured to mesh with the second pinion according to the movement of the paper feeding tray in the drawing-out direction and rotate the second pinion.

14. The paper feeding unit according to claim 12, wherein
the rotating section includes:
a third rotating body configured to rotate the winding body in the reverse rotating direction in a state of being in contact with an outer circumferential surface of the winding body in a direction orthogonal to a rotation axis of the winding body;
a second pinion provided in the paper feeding tray and configured to transmit a rotational force to the third rotating body; and
a second rack provided in the housing and configured to mesh with the second pinion according to the movement of the paper feeding tray in the drawing-out direction and rotate the second pinion, and
the second pinion meshes with the second rack when the first pinion and the first rack mesh with each other.

15. The paper feeding unit according to claim 12, wherein
the rotating section includes:
a fourth rotating body configured to rotate the winding body in the reverse rotating direction in a state of being in contact with an outer circumferential surface of the winding body in a direction orthogonal to a rotation axis of the winding body;
a second pinion provided in the paper feeding tray and configured to transmit a rotational force to the fourth rotating body; and
a second rack provided in the housing and configured to mesh with the second pinion according to the movement of the paper feeding tray in the drawing-out direction and rotate the second pinion, and
the second rack is configured integrally with the first rack.

16. The paper feeding unit according to claim 13, further comprising a pressing section configured to come into contact with an outer circumferential surface of the winding body in a direction orthogonal to a rotation axis of the winding body and press the winding body against the third rotating body.

17. A printing apparatus comprising:
the paper feeding unit according to claim 1; and
a printing section, wherein
the paper feeding tray is capable of storing each of the winding body and one or more pieces of cut paper, and
the printing section prints an image on the roll paper let out from the winding body stored in the paper feeding tray or the cut paper.

18. The printing apparatus according to claim 17, wherein the rotating section comes into contact with none of the one or more pieces of cut paper.

19. The printing apparatus according to claim 17, further comprising a cutting section configured to cut the roll paper.
